(19) United States
(12) Patent Application Publication
(10) Pub. No.: US 2026/0113169 A1
(43) Pub. Date: Apr. 23, 2026

(54) METHODS, DEVICES, AND MEDIUM FOR COMMUNICATION

(71) Applicant: NEC Corporation, Tokyo (JP)

(72) Inventors: Peng GUAN, Beijing (CN); Yukai GAO, Beijing (CN); Gang WANG, Beijing (CN)

(73) Assignee: NEC Corporation, Tokyo (JP)

(21) Appl. No.: 19/113,258

(22) PCT Filed: Sep. 29, 2022
(86) PCT No.: PCT/CN2022/122856

§ 371 Date: Mar. 19, 2025

(51) Int. Cl. H04L 5/00; H04L 1/1812

(52) U.S. Cl. CPC H04L 5/0091; H04L 1/1812

(57) ABSTRACT

Example embodiments of the present disclosure relate to a solution for communications with multiple Timing Advance Groups (TAGs). In this solution, a terminal device receives, from a network device, configuration information indicating a plurality of timing advance groups (TAGs) associated with a first cell of the terminal device. The terminal device determines, during a communication procedure with the network device, at least one running state of at least one timer among a plurality of timers associated with the plurality of TAGs; and performs an action for the communication procedure based on the at least one running state of the at least one timer.

### FIELD

Example embodiments of the present disclosure generally relate to the field of communication techniques and in particular, to methods, devices, and medium for communications with multiple Timing Advance Groups (TAGs).

### BACKGROUND

Timing Advance (TA) is used to adjust uplink (UL) transmission timing. Conventionally, one TA is associated with one Timing Advance Group (TAG), and one serving cell is associated with one TAG. Currently, it is proposed to specify two TAs for communication, for example, to support UL multi-downlink control information (DCI) and multi-transmission and reception point (MTRP) operations. Moreover, two TAGs for two TAs may be configured for one serving cell. Specific operations with multiple TAGs may thus be desired.

### SUMMARY

In general, embodiments of the present disclosure provide methods, devices and computer storage medium for communications with multiple TAGs.

In a first aspect, there is provided a communication method. The method comprises: receiving, at a terminal device and from a network device, configuration information indicating a plurality of timing advance groups (TAGs) associated with a first cell of the terminal device; determining, during a communication procedure with the network device, at least one running state of at least one timer among a plurality of timers associated with the plurality of TAGs; and performing an action for the communication procedure based on the at least one running state of the at least one timer.

In a second aspect, there is provided a communication method. The method comprises: receiving, at a terminal device and from a network device, configuration information indicating a plurality of timing advance groups (TAGs) associated with a first cell of the terminal device; receiving, from the network device, a plurality of timing advance (TA) commands for the plurality of TAGs; determining a start time point for the plurality of TAGs, the start time point indicating when the plurality of TA commands are to be applied; and in accordance with a determination that an active BWP of the first cell is configured with a multi-transmission reception point (MTRP) mode, applying the plurality of TA commands from the determined start time point.

In a third aspect, there is provided a communication method. The method comprises: receiving, at a terminal device and from a network device, configuration information indicating a plurality of timing advance groups (TAGs) associated with a cell for the terminal device; selecting a target TAG from the plurality of TAGs based on a TAG selection criterion for a communication procedure; and performing the communication procedure with the network device based at least on the target TAG.

In a fourth aspect, there is provided a terminal device. The terminal device includes a processing unit; and a memory coupled to the processing unit and storing instructions thereon, the instructions, when executed by the processing unit, causing the device to perform the method according to any of the first aspect, the second aspect, and the third aspect.

In a fifth aspect, there is provided a computer readable medium having instructions stored thereon, the instructions, when executed on at least one processor, causing the at least one processor to carry out the method according to any of the first aspect, the second aspect, and the third aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates an example of TA in communications with multiple TRPs in accordance with some embodiments of the present disclosure;

FIG. 3 illustrates a flowchart of a communication method in accordance with some embodiments of the present disclosure;

FIG. 4 illustrates a diagram showing an example of configuration of TAGs in accordance with some embodiments of the present disclosure;

FIG. 5 illustrates a flowchart of a communication method in accordance with some embodiments of the present disclosure;

FIG. 6A illustrates a diagram showing an example of an association relationship between bandwidth parts (BWPs) and TAGs in accordance with some embodiments of the present disclosure;

FIG. 6B illustrates a diagram of an example timeline showing TA command reception, BWP switching, and TA command applying in accordance with some embodiments of the present disclosure;

FIG. 7 illustrates a diagram of an example association relationship between BWPs and TAGs in accordance with some embodiments of the present disclosure;

FIG. 8 illustrates a diagram of an example configuration for TAGs and CC lists in accordance with some embodiments of the present disclosure;

FIG. 9 illustrates a diagram of an example configuration for TAGs and cell groups by MAC entities in accordance with some embodiments of the present disclosure;

FIG. 10 illustrates a diagram showing a further example of configuration of TAGs in accordance with some embodiments of the present disclosure;

FIGS. 11A-11B illustrate diagrams showing examples of a MAC CE used to indicate TA commands in accordance with some embodiments of the present disclosure;

FIGS. 12A-12B illustrate diagrams showing examples of SCS selection for determining indicated TA values in accordance with some embodiments of the present disclosure;

FIG. 13 illustrates a flowchart of an example communication method in accordance with some further embodiments of the present disclosure;

FIG. 14 illustrates a flowchart of an example communication method in accordance with some yet further embodiments of the present disclosure;

FIG. 15A illustrates an example BFR procedure in accordance with some embodiments of the present disclosure;

FIG. 15B illustrates an example table showing an association between TAG, resource pool, and RSs for BFR in accordance with some embodiments of the present disclosure; and

FIG. 16 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (cNodeB or cNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,” ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

The terms “SRI”, “SRS resource set index”, “UL TCI”, “UL spatial domain filter”, “UL beam”, “joint TCI” can be used interchangeably.

Regarding the CG PUSCH, the term “PUSCH transmission” used herein can refer to a nominal transmission or refer to an actual transmission.

The terms “transmission capability information”, “UE capability information”, “capability-related information”, “capability value set”, “panel information” and “panel-related information” can be used interchangeably.

The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably.

The terms “single TRP”, “single TCI state”, “single TCI”, “S-TCI”, “single CORESET”, “single control resource set pool”, “S-TRP” and “S-TCI state” can be used interchangeably.

The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably.

The terms “resource(s)”, “resource(s) in a resource set”, “resource set” can be used interchangeably.

The terms “group”, “subset”, “set” can be used interchangeably.

Further, one panel discussed herein refers to one or more antenna elements deployed at a certain area of a terminal device. A panel discussed herein can refer to downlink panel, uplink panel, panel type, panel status, capability value set, reference signal (RS) resource, RS resource set, antenna port, antenna port group, beam, beam group. In this regard, the terms (and their equivalent expressions) “panel”, “panel type”, “set of antenna port(s)”, “antenna element(s)”, “antenna array(s)” can be used interchangeably.

In addition, panel information discussed herein can refer to UE panel index/identification (ID), downlink panel ID, uplink panel ID, panel type indication, panel status indication, capability value set index, RS resource ID, RS resource set ID, antenna port ID, antenna port group ID, beam ID, beam group ID.

The term “BWP ID/index” can be used interchangeably with “BWP/CC ID/index”, “CC identity/index”, “cell identity/index”, “cell group identity/index”, “physical cell identity/index” and “serving cell identity/index”.

The term “beam failure” can be used interchangeably with “link failure”, “beam failure recovery request” can be used interchangeably with “link recovery request”.

Embodiments of the present disclosure provide a solution for communications with multiple Timing Advance Groups (TAGs). Principles and implementations of the present disclosure will be described in detail below with reference to the figures.

FIG. 1 illustrates a schematic diagram of an example communication environment 100 in which example embodiments of the present disclosure can be implemented. In the communication environment 100, a plurality of communication devices are involved, including a terminal device 110 and a plurality of network devices 120-1, and 120-2. For the purpose of discussion, the network devices 120-1 and 120-2 are collectively or individually referred to as network devices 120.

It is to be understood that the number of devices and their connections in FIG. 1 are given for the purpose of illustration without suggesting any limitations to the present disclosure. The communication environment 100 may include any suitable number of devices adapted for implementing embodiments of the present disclosure. For example, there may be more terminal devices and/or network devices in the communication environment 100. Although not shown, the communication environment 100 may involve a core network with core network devices for supporting the communications.

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In the communication environment 100, the terminal device 110 may communicate with one or more network devices 120. In some embodiments, the network devices 120 may include transmission-reception points (TRPs). A network device 120 which serves the terminal device 110 may be referred to as a serving network device of the terminal device 110. In some example embodiments, a link from a network device 120 to the terminal device 110 is referred to as a downlink (DL), while a link from the terminal device 110 to a network device 120 is referred to as an uplink (UL).

During communication, to enable synchronization, TA is used to adjust UL transmit timing. Specifically, an UL frame number i for transmission from a terminal device starts

$${T}_{T A} = ( {N}_{T A} + {N}_{T A , offset} + {N}_{T A , a d j}^{c o m m o n} + {N}_{T A , a d j}^{U E} ) {T}_{c}$$

before the start of the corresponding DL frame at the terminal device, where N_{TA} is indicated in a timing advance command or in an absolute timing advance command T_{A}, N_{TA}.offset is a timing advance offset in a timing advance command,

$${N}_{T A , a d j}^{c o m m o n}$$

is derived from the higher-layer parameters or is a default value, and

$${N}_{TA , adj}^{U E}$$

is computed based on satellite-ephemeris-related higher-layers parameters if configured or is a default value. In some examples, T_{c}=1/(Δfₘₐₓ·N_{f}) where Δfmax=480·10\hat{ }3 Hz and N_{f}=4096.

In this disclosure, T_{c} is a basic timing unit, where T_{c}=1/(Δfmax·N_{f}), Δfmax=480·10³ Hz, N_{f}=4096. Other time units can be a millisecond (ms), a frame, a subframe, a slot, a symbol, they can be converted to each other, and converted to Tc as following: frame length T_{f}=(Δfmax·N_{f}/100)·T_{c}=10 ms, and each frame consisting of ten subframes. The number of consecutive OFDM symbols per subframe is

$${N}_{symb}^{subframe , μ} = {N}_{symb}^{slot} {N}_{slot}^{subframe , μ} .$$

Further, slots are numbered

$${n}_{s}^{μ} ∈ \{ 0 , … , {N}_{slot}^{subframe , μ} - 1 \}$$

is increasing order within a subframe and

$${n}_{s , f}^{μ} ∈ \{ 0 , … , {N}_{slot}^{frame , μ} - 1 \}$$

in increasing order within a frame. Further, other parameters associated with above timing unit conversion are shown in the following tables. Table 1 shows an example of the supported transmission numerologies.

TABLE 1

| μ | Δf = 2^{μ} · 15 KHz | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

Table 2 shows an example of the number of OFDM symbols per slot, slots per frame, and slots per subframe for normal cyclic prefix.

TABLE 2

| μ | ${N}_{symb}^{slot}$ | ${N}_{slot}^{frame , u}$ | ${N}_{slot}^{subframe , u}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

Table 3 shows an example of the number of OFDM symbols per slot, slots per frame, and slots per subframe for extended cyclic prefix.

TABLE 3

| μ | ${N}_{symb}^{slot}$ | ${N}_{slot}^{frame , u}$ | ${N}_{slot}^{subframe , u}$ |
|---|---|---|---|
| 2 | 12 | 40 | 4 |

Upon reception of a timing advance command for a TAG, the terminal device adjusts UL timing for transmission on all the serving cells in the TAG based on a value N_{TA,offset} that the UE expects to be same for all the serving cells in the TAG and based on the received timing advance command where the UL timing for transmissions is the same for all the serving cells in the TAG. A terminal device can be provided a value N_{TA,offset} of a timing advance offset for a serving cell by n-TimingAdvanceOffset for the serving cell. If the UE is not provided n-TimingAdvanceOffset for a serving cell, the UE determines a default value N_{TA,offset} of the timing advance offset for the serving cell.

A timing advance command in case of random access response or in an absolute timing advance command media access control (MAC CE), T_{A}, for a TAG indicates N_{TA} values by index values of T_{A}=0, 1, 2, . . . , 3846, where an amount of the time alignment for the TAG with SCS of 2^{μ}·15 KHz is N_{TA}=T_{A}·16·64/2^{μ}. N_{TA} is defined as relative to a subcarrier spacing (SCS) of the first uplink transmission from the terminal device after the reception of the random access response or absolute timing advance command MAC CE. In other cases, a timing advance command, T_{A}, for a TAG indicates adjustment of a current N_{TA} value, N_{TA_old}, to the new N_{TA} value, N_{TA_new}, by index values of T_{A}=0, 1, 2, . . . , 63, where for a SCS of 2^{μ}·15 KHz, N_{TA_new}=N_{TA_old}+(T_{A}−31)·16·64/2^{μ}.

Generally, a TA may be configured and updated for a TAG. A TAG may comprise a group of cells that is configured by radio resource control (RRC) and that, for the cells with a UL configured, using the same timing reference cell and the same Timing Advance value. In some cases, a Timing Advance Group containing the SpCell of a MAC entity is referred to as a Primary Timing Advance Group (PTAG), whereas the term Secondary Timing Advance Group (STAG) refers to other TAGs.

Conventionally, one TA is associated with one Timing Advance Group (TAG), and one TAG is associated with one serving cell. Currently, it is proposed to specify two TAs for communication, for example, to support UL multi-downlink control information (DCI) and multi-transmission and reception point (MTRP) operation. In the MTRP operation, a terminal device may communicate with multiple MTRPs, for example, the terminal device 110 may communicate with both the network devices 120-1 and 120-2 in FIG. 1. Possible scenarios in the MTRP operation may include DL with one TRP and UL with other TRP, DL with both TRPs and UL with one TRP, DL with one TRP and UL with both TRPs, or DL and UL with both TRPs, assuming that two TRPs are involved.

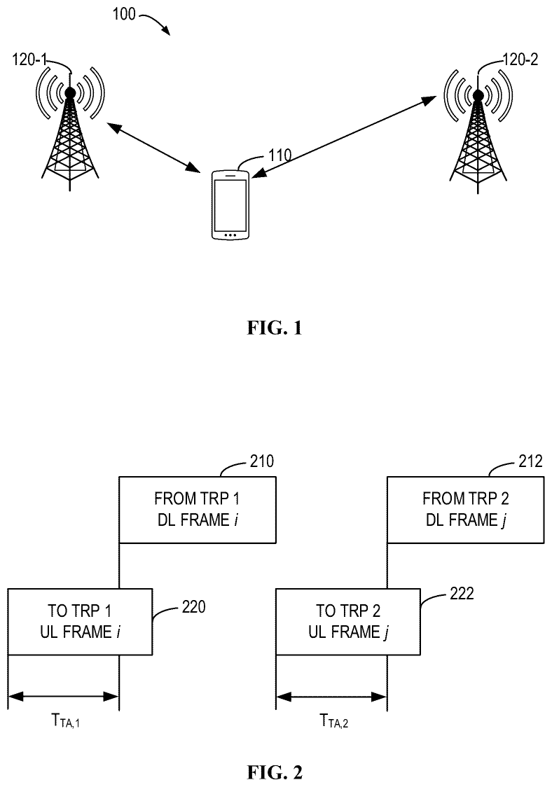

UL timing with different MTRPs may be different. As shown in FIG. 2, start timing T_{TA,1} of an UL frame number i 220 for transmission to TPR 1 is determined relative to a DL frame i 210 from TRP 1; and start timing T_{TA,2} of an UL frame number j 222 for transmission to TPR 2 is determined relative to a DL frame j 212 from TRP 2. T_{TA,1} and T_{TA,2} may be different, for example, considering the distances from the terminal device to the two TRPs and other channel conditions. If TA is measured or signaled between TRP 1 and the terminal device, it may not be suitable for communications between TRP 2 and the terminal devices. Similar issues may occur for different UE panels and TRPs. Therefore, two or more TAs may be needed and thus two or more TAGS are configured for respective TAs.

If multiple TAGs are configured, it may be contradictory to legacy TAG definition where a group of cells that is configured by RRC and that, for the cells with a UL configured, using the same timing reference cell and the same Timing Advance value. Therefore, specific operations with multiple TAGs may need to be carefully designed and specified, to maintain consistency during communications and guarantee the communication performance.

Example embodiments of the present disclosure provide solutions for communications with a plurality of TAGs. In some embodiments, specific operations for a terminal device are provided, to allow the terminal device to correctly apply TA commands for a plurality of TAGs. In some embodiments, specific configurations, indications, and/or device capabilities for supporting the plurality of TAGs for a certain cell are provided. In some embodiments, a plurality of timers associated with the plurality of TAGs are triggered, and thus performance of certain communication procedures relies on the timers are configured, to enable completion of those communication procedures. In some embodiments, TA value alignment within a cell is proposed, to allow performance of certain communication procedures.

Principles and implementations of the present disclosure will be described in detail below with reference to the figures.

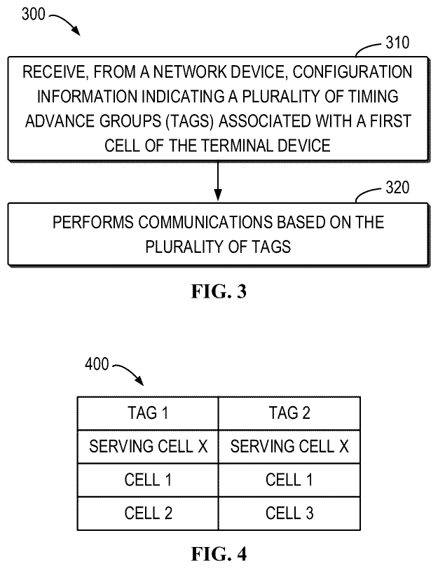

Reference is made to FIG. 3, which illustrates a flowchart of a communication method 300 in accordance with some embodiments of the present disclosure. The method 300 may be implemented at a terminal device. For the purpose of discussion, the method 300 will be described with reference to FIG. 1, and the method 300 may be implemented at the terminal device 110.

At block 310, the terminal device 110 receives, from a network device, configuration information indicating a plurality of timing advance groups (TAGs) associated with a first cell of the terminal device 110. Here, a first cell may be a serving cell of the terminal device 110. In some examples, the configuration information to the terminal device may indicate identities (IDs) of the plurality of TAGs.

A TAG may involve one or more cells. In embodiments of the present disclosure, it is assumed that the serving cell (referred to as “first cell” here) of the terminal device 110 belongs to a plurality of TAGs. Cells in a same TAG may share a same TA value for UL transmission timing.

FIG. 4 illustrates an example of configuration 400 of two TAGs. As shown, a first TAG (TAG 1) is associated with Serving Cell x, Cell 1, Cell2; a second TAG (TAG 2) is associated with Serving Cell x, Cell 1, and Cell 2. It is assumed that the terminal device 110 is within coverage of Serving Cell x and thus may receive configuration information indicating TAG 1 and TAG 2. It is noted that the example in FIG. 4 is provided for the purpose of illustration only and the mappings between the cells and TAGs may be different, more, less, and different cells and TAGs may be configured.

In some embodiments, the plurality of TAGs may include a first TAG and a second TAG. In some embodiments, the plurality of TAGs may include more than two TAGs.

If the plurality of TAGs are configured, during communications, behaviors or operations of the terminal device 110 may be determined according to the plurality of TAGs. At block 320, the terminal device 110 performs communications based on the plurality of TAGs.

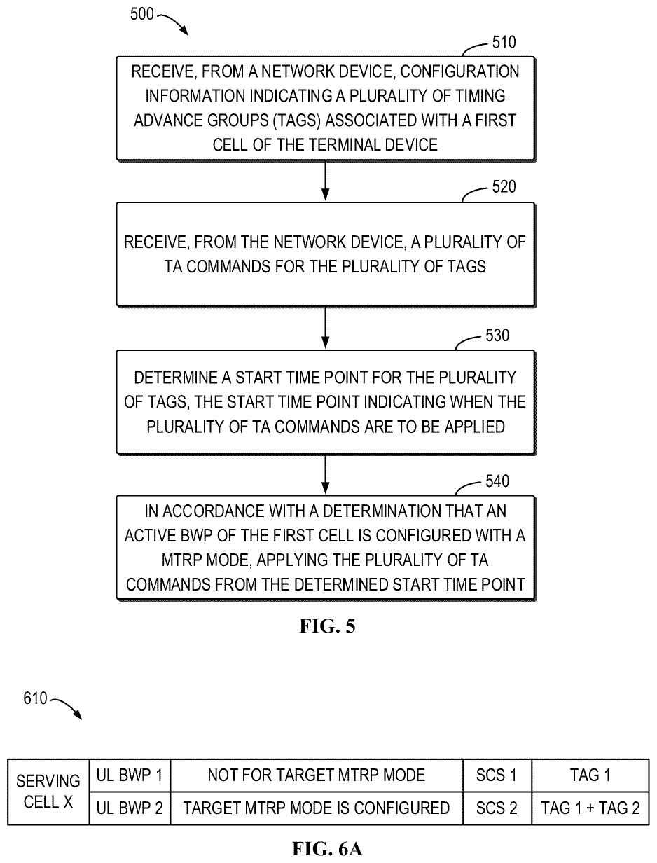

FIG. 5 illustrates a flowchart of a communication method 500 implemented at a terminal device in accordance with some embodiments. The method 500 may be implemented by the terminal device to determine how TA commands are applied for UL timing. For the purpose of discussion, the method 500 will be described with reference to FIG. 1, and the method 500 may be implemented at the terminal device 110.

At block 510, the terminal device 110 receives, from a network device, configuration information indicating a plurality of TAGs associated with a first cell of the terminal device 110. In the case that a plurality of TAGs are configured, at block 520, the terminal device 110 receives, from the network device, a plurality of TA commands for the plurality of TAGs.

In some embodiments, two TAs of the two TAGs for a serving cell can be calculated as T_{ADV,1}=(T_{TRP1-RX, PRACH1}−T_{TRP1-TX}), T_{ADV,2}=(T_{TRP2-RX, PRACH2}−T_{TRP2-TX}), respectively. Assuming that TRP 1 and PRACH 1 is associated with TAG 1 and TRP 2 and PRACH 2 is associated with TAG 2, T_{TRP1-RX} is the TRP 1 received timing of uplink subframe #i containing PRACH 1 transmitted from the terminal device for TAG 1, defined by the first detected path in time, and T_{TRP1-TX} is the TRP transmit timing of downlink subframe #j that is closest in time to the subframe #i received from the terminal device. T_{TRP2-RX} is the TRP 2 received timing of uplink subframe #i containing PRACH 2 transmitted from the terminal device for TAG 2, defined by the first detected path in time, and T_{TRP2-TX} is the TRP transmit timing of downlink subframe #j that is closest in time to the subframe #i received from the terminal device.

In some embodiments, two TAs of the two TAGs can be calculated cross TRPs as T_{ADV,1}=(T_{TRP1-RX, PRACH2}−T_{TRP1-TX}+offset1), T_{ADV,2}=(T_{TRP1-RX, PRACH1}−T_{TRP2-TX}−offset1) respectively. T_{TRP1-RX} is the TRP 1 received timing of uplink subframe #i containing PRACH 2 transmitted from the terminal device for TAG 2, defined by the first detected path in time, T_{TRP1-TX} is the TRP transmit timing of downlink subframe #j that is closest in time to the subframe #i received from the terminal device. T_{TRP2-RX} is the TRP 2 received timing of uplink subframe #i containing PRACH 1 transmitted from UE for TAG 1, defined by the first detected path in time, T_{TRP2-TX} is the TRP transmit timing of downlink subframe #j that is closest in time to the subframe #i received from the terminal device. offset1 is the propagation difference between TRP 1 and TRP 2, and offset1 can be a positive or negative value. In some embodiments, offset1 is signaled by the network device. In some embodiments, offset1 can be reported by the terminal device.

In some other embodiments, if PRACH 1 or PRACH 2 is transmitted with non-zero TA, an additional offset2 is needed for calculation of T_{ADV,1} or T_{ADV,2} respectively. In some embodiments, offset2 is signaled by the network device. In some embodiments, offset2 can be reported by the terminal device.

In some embodiments, T_{TRP1-TX} and T_{TRP2-TX} can be the same. Alternatively, or in addition, T_{TRP1-TX} and T_{TRP2-TX} can be different and T_{ADV,1}=(T_{TRP1-RX}-T_{TRP2-TX}+offset3), T_{ADV,2}=(T_{TRP2-RX}−T_{TRP1-TX}-offset3), where offset3 is the transmit timing difference between T_{TRP1-TX} and T_{TRP2-TX} and offset3 can be a positive or negative value. In some embodiments, offset3 is signaled by the network device. In some embodiments, offset3 can be reported by the terminal device.

The reference point for T_{TRP-RX} (e.g., T_{TRP1-RX, PRACH1}, T_{TRP1-RX, PRACH2}, T_{TRP2-RX, PRACH1}, T_{TRP1-RX, PRACH2}) might be one of the following:
the Rx antenna connector of the corresponding TRP,
the Rx antenna of the corresponding TRP (i.e. the centre location of the radiating region of the Rx antenna),
the Rx Transceiver Array Boundary connector of the corresponding TRP.
   The reference point for T_{TRP-RX} (e.g., T_{TRP1-TX}, T_{TRP2-TX}) might be one of the following:
the Tx antenna connector of the corresponding TRP,
the Tx antenna of the corresponding TRP (i.e. the centre location of the radiating region of the Tx antenna),
the Tx Transceiver Array Boundary connector of the corresponding TRP.

The plurality of T_{A} commands are applied to control T_{A} values for the plurality of TAGs. In some embodiments, UL transmission timing, for example, a start time T_{TA} of an UL frame for transmission from the terminal device 110 may be determined according to

$${T}_{TA} = ( {N}_{TA} + {N}_{TA , offset} + {N}_{TA , adj}^{common} + {N}_{TA , adj}^{UE} ) {T}_{c} .$$

In some example, a TA command for a TAG may indicate one or more of the following parameters T_{TA}, N_{TA}, or N_{TA,offset}. Other parameters for calculating T_{TA} may be calculated or determined in other ways. In some example, the terminal device 110 may determine for the respective TAG the first TA value “T_{TA,1}” and the second TA value “T_{TA,2}” based on T_{TA,1}=(N_{TA,1}+N_{TA,offset,1})T_{c} and T_{TA,2}=(N_{TA,2}+N_{TA,offset,2})T_{c}. In some example, the terminal device 110 may determine for the respective TAG the first TA value “T_{TA,1}” and the second TA value “T_{TA,2}” based on T_{TA,1}=(N_{TA,1}+N_{TA,offset})T_{c} and T_{TA,2}=(N_{TA,}+N_{TA,offset}+N_{TA,offset,add})T_{c}, where “N_{TA, offset, add}” indicates an additional TA value.

In some examples, a TA command in case of random access response or in an absolute timing advance command, T_{A}, for a TAG may indicate N_{TA} whose values are indicated by index values of T_{A}=0, 1, 2, . . . , 3846. In some examples, the terminal device 110 may be provided with a value N_{TA,offset} of a timing advance offset for a TAG. In some examples, a timing advance command T_{A}, for a TAG may indicate adjustment of a current N_{TA} value, N_{TA_old}, to the new N_{TA} value, N_{TA_new}, by index values of T_{A}=0, 1, 2, . . . , 63.

Some example TA commands are provided above. A TA command for a TAG may be provided in other ways or indicate other information or values for the terminal device to determine UL transmission timing for a TAG.

In some embodiments, the TA commands may be received together with the configuration information about the corresponding TAGs. For example, the terminal device 110 may receive a media control access (MAC) control element (CE) which indicates both the TAGs and corresponding TA commands. In some embodiments, the TA commands may be indicated separately from the configuration of the TAGs.

Upon reception of the plurality of TA commands, the terminal device 110 may determine when and how to apply the plurality of TA commands, for example, to adjust the UL transmission timing. At block 530, the terminal device 110 determines a start time point for the plurality of TAGs. The start time point indicates when the plurality of TA commands are to be applied.

In embodiments of the present disclosure, it is proposed that if a plurality of TAGs are associated with a same serving cell for the terminal device 110, the terminal device 110 applies the corresponding TA commands for the TAGs from a same time point.

In some embodiments, the start time point may be determined to indicate that corresponding adjustment of UL transmission timing applies from the beginning of a certain uplink slot. The start time point or this uplink slot may be determined based at least in part on information bandwidth parts (BWP) related information in a TAG. In some examples, a reference SCS of a BWP is determined within a TAG to determine the start time point. The reference SCS may be the minimum SCS.

As an example, the number of the uplink slot may be determined through n+k+1+2^{μ}·K_{offset}. The predetermined parameter k may be determined as follows:

$$k = ⌈ {N}_{slot}^{subframe , μ} \cdot ( {N}_{T , 1} + {N}_{T , 2} + {N}_{TA , max} + 0 \text{.5} ) / {T}_{sf} ⌉ ,$$

where N_{T,1} is a time duration in msec of N₁ symbols corresponding to a PDSCH processing time for UE processing capability 1 when additional PDSCH DM-RS is configured; N_{T,2} is a time duration in msec of N₂ symbols corresponding to a PUSCH preparation time for UE processing capability 1; N_{TA,max} is the maximum timing advance value in msec that can be provided by a TA command field of 12 bits;

$${N}_{slot}^{subframe , μ}$$

is the number of slots per subframe; T_{sf} is the subframe duration of 1 msec. K_{offset}=K_{cell,offset}−K_{UE,offset}, where K_{cell,offset} and K_{UE,offset} are provided by signalling, for example, K_{cell,offset} may be provided by Koffset in ServingCellConfigCommon and K_{UE,offset} is provided by a MAC CE command; otherwise, if not respectively provided, K_{cell,offset}=0 or K_{UE,offset}=0. N₁ and N₂ may be determined with respect to the minimum SCS among the SCSs of all configured UL BWPs for all uplink carriers in a TAG and of all configured DL BWPs for the corresponding downlink carriers. For μ=0, the terminal device may assume N_{1,0}=14. Slot n and Nₛₗₒₜ^{subframe, μ} may be determined with respect to the minimum SCS among the SCSs of all configured UL BWPs for all uplink carriers in the TAG. N_{TA,max} may be determined with respect to the minimum SCS among the SCSs of all configured UL BWPs for all uplink carriers in the TAG and for all configured initial UL BWPs.

Since the determination of the start time point, or the predetermined parameter k for the uplink slot n+k+1+2^{μ}·K_{offset} may be varied according to the TAG. In the case that a plurality of TAGs are configured, the terminal device 110 may determine a plurality of potential start time points for different TAGs. In some embodiments, the terminal device 110 may determine a plurality of values for the predetermined parameter k for calculating the start time point based on corresponding BWP related information in the plurality of TAGs, and select one of the determined values for the predetermined parameter k to determine the start time point.

For example, for a first TAG, TAG 1, the terminal device 110 may determine

$$k 1 = ⌈ {N}_{slot}^{subframe , μ} \cdot ( {N}_{T , 1} + {N}_{T , 2} + {N}_{TA , max} + 0 \text{.5} ) / {T}_{sf} ⌉ .$$

In calculation of k1,

$${N}_{slot}^{subframe , μ} , {N}_{T , 1} , {N}_{T , 2} and {N}_{TA , max}$$

may be determined based on BWP related information in TAG 1, for example, based on SCSs of BWPs configured for cells in TAG 1. For a second TAG, TAG 2, the terminal device 110 may determine

$$k 2 = ⌈ {N}_{slot}^{subframe , μ} \cdot ( {N}_{T , 1} + {N}_{T , 2} + {N}_{TA , max} + 0 \text{.5} ) / {T}_{sf} ⌉ ,$$

where the parameters for calculating k2 may be determined based on BWP related information in TAG 2, for example, based on SCSs of BWPs configured for cells in TAG 2. In some embodiments, for either of TAG 1 and TAG 2, a reference SCS (e.g., the minimum SCS) among the SCSs of UL and/DL configured BWPs in the corresponding TAG may be used to determine k1, k2.

In some embodiments, among multiple values for the predetermined parameter k, the terminal device 110 may select the relatively larger one or the largest one of the values. For example, the uplink slot for the start time point may be determined as n+max (k1, k2)+1+2^{μ}·K_{offset} in the case of two TAGs. That is, the latter one of k1, k2 may be selected for determining the start time point.

In some embodiments, a reference SCS may be determined based on BWP related information in all the plurality of TAGs and used to determine a single value for the predetermined parameter k. For example, the reference SCS used to determine of N₁, N₂, Slot n,

$${N}_{slot}^{subframe , μ} , and {N}_{TA , max}$$

may be determined among SCSs within the plurality of TAGs. For example, the minimum SCS of UL and/or DL BWPs in the plurality of TAGs may be determined and used to calculate N₁, N₂, Slot n,

$${N}_{slot}^{subframe , μ} , and {N}_{TA , max} .$$

In some example, the minimum SCS among the SCSs of all configured UL BWPs for all uplink carriers in the plurality of TAGs and of all configured DL BWPs for the corresponding downlink carriers is used to calculate N₁, N₂, the minimum SCS among the SCSs of all configured UL BWPs for all uplink carriers in the plurality of TAGs is used to calculate slot n and

$${N}_{slot}^{subframe , μ}$$

the minimum SCS among the SCSs of all configured UL BWPs for all uplink carriers in the plurality of TAGs and for all configured initial UL BWPs provided by initialUplinkBWP is used to calculate N_{TA,max}. The predetermined parameter k may be obtained accordingly, to determine the uplink slot n+k+1+2^{μ}·K_{offset}.

It would be appreciated that a specific example for calculation of the start time point is provided above. The calculation of the start time point may be carried out in other ways, and the parameters used may be adapted accordingly.

With start time point determined, at block 540, in accordance with a determination that an active BWP of the first cell for the terminal device 110 is configured with a MTRP mode, the terminal device 110 applies the plurality of T_{A} commands from the determined start time point. In some embodiments, a plurality of T_{A} values are useful in the MTRP mode when the terminal device 110 communicates with multiple TRPs.

In a certain cell, a MTRP mode may be configured per BWP. Specifically, if a cell is configured with a plurality of BWPs (for example, UL BWPs), one or more of those BWPs may be configured with the MTRP mode. In some examples, the MTRP mode may be UL multi-DCI for MTRP mode, which may be referred to as “target MTRP mode” herein. In some examples, the target MTRP mode can be multi-DCI based MTRP for PUSCH, multi-DCI based MTRP for PUCCH, multi-DCI based MTRP STxMP (simultaneous uplink transmission cross multiple panels) for PUCCH and/or PUSCH. In some embodiments hereinafter, the target MTRP mode may be used as an example although other MTRP modes may also be configured.

If the terminal device 110 determines that an active BWP (for example, an active UL BWP) is configured with the MTRP mode, the terminal device 110 may decide to apply the plurality of TA commands. Here, an active BWP indicates that the terminal device 110 operates using this BWP with the network device. Since this BWP is configured with the MTRP mode, the terminal device 110 may need to operate with a plurality of TAs for different TRPs.

In those embodiments, at least for the active UL BWP(s) configured with the MTRP mode, the terminal device 110 apply the TA commands from the determined start time point. As such, the applying timing of TA values in the TA commands may be aligned for the MTRP operation.

In some embodiments, the terminal device 110 may switch between BWPs in a cell. The BWP switching may occur before or after the time of applying the TA commands. The terminal device 110 may have different behaviors considering the BWP switching time.

In some embodiments, a TA value is determined based on the TA command and a reference SCS of a certain BWP. For example, a TA command may indicate adjustment of a current N_{TA} value, N_{TA_old}, to the new N_{TA} value, N_{TA_new}, where N_{TA} is used to determine the

$$TA value {T}_{TA} = ( {N}_{TA} + {N}_{TA , offset} + {N}_{TA , adj}^{common} + {N}_{TA , adj}^{UE} ) {T}_{c} .$$

N_{TA} value may be determined as N_{TA}=T_{A}·16·64/2^{μ}. The new N_{TA} value may be determined as follows: N_{TA_new}=N_{TA_old}+(T_{A}−31)·16·64/2^{μ}. Here, the parameter u indicates the reference SCS of a BWP.

In the case of BWP switching, for example, switching from a first BWP to a second BWP, the reference SCS may change. In some embodiments, if the terminal device 110 changes an active UL BWP between a time of a timing advance command reception and a time of applying a corresponding adjustment for the uplink transmission timing, the terminal device 110 may determine the TA value based on the SCS of the new active UL BWP, for example, the second BWP. In some embodiments, if the TA command cannot be applied for the new active UL BWP, the terminal device 110 may determine determines the TA value based on the SCS of the previous active UL BWP when the TA command was received.

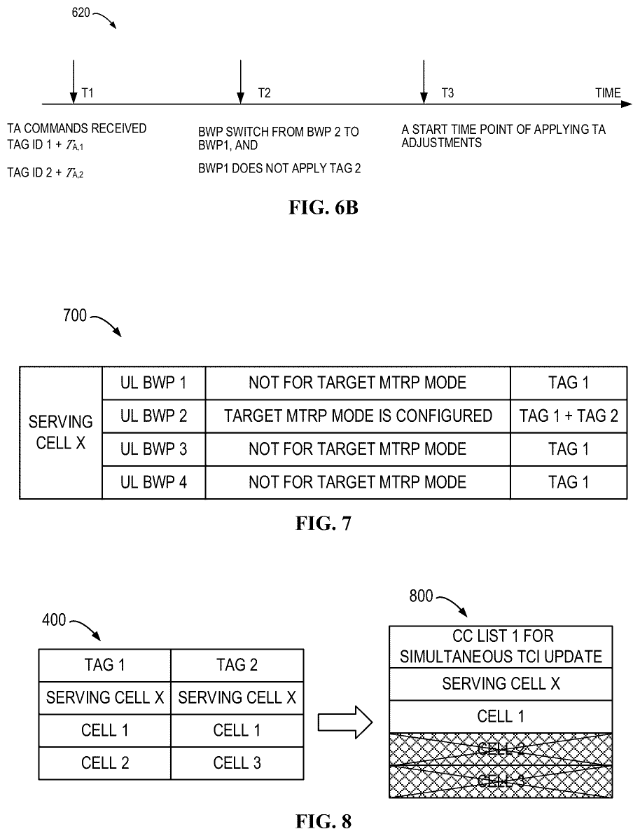

In some cases, in addition to the MTRP mode, different BWPs in a cell may be configured to be associated with different TAGs. An example of association relationship 610 is shown in FIG. 6A. In this example, Serving Cell x of the terminal device is associated with both TAG 1 and TAG 2. UL BWP 1 of Serving Cell x is not configured for a target MTRP mode and is associated with TAG 1, while UL BWP 2 is configured for the target MTRP mode and are associated both TAG 1 and TAG 2. UL BWP 1 has SCS1 and UL BWP 2 has SCS2.

FIG. 6B shows an example timeline 620 of T_{A} command reception (at a time of T1), BWP switching (at a time of T2), and TA command applying (at a time of T3). In this example, the BWP switching from BWP2 to BWP1 completes between the time of TA command reception (T1) and the start time point of T_{A} command applying (T3).

Since the terminal device 110 switches from BWP2 to BWP1, and the active BWP (BWP1 in this example) is associated with TAG 1, a TA value for TAG 1 may be determined based on a received TA command for this TAG and a reference SCS (SCS1) of BWP1. For example, the new N_{TA} value may be determined as follows: N_{TA_new}=N_{TA_old}+(T_{A}−31)·16·64/2^{μ}, where μ can be SCS1 of BWP 1.

For TAG 2, since the active BWP (BWP 1 in this example) is not associated with TAG2 according to the association relationship in FIG. 6A, BWP 1 does not apply the adjustment indicated by the received T_{A} command for TAG 2. In some embodiments, the terminal device 110 may still use SCS of the previous active BWP (BWP 2) to calculate the TA value for TAG 2. Thus, a TA value for TAG 2 may be determined based on a received T_{A} command for the second TAG and a reference SCS of the first BWP, which may be represented as follows: N_{TA_new}=N_{TA_old}+(T_{A}−31)·16·64/2^{μ2}, where μ2 can be SCS2 of BWP2.

The above embodiments are described with reference to two TAGs. If more than two TAGs are configured, the reference SCSs and thus TA values for those TAGs may be determined in a similar way.

In some embodiments, if the terminal device 110 changes an active UL BWP after applying the TA commands (that is, an adjustment for the uplink transmission timing has been applied), the terminal device 110 may assume at least one same absolute timing advance command value before and after the active UL BWP change. That is, the terminal device 110 may maintain at least one of the plurality of TA values for at least one of the plurality of TAGs.

In an example, it is assumed that the BWP switching is from BWP 1 to BWP 2. With a precondition of the association relationship in FIG. 6A, before such BWP switching, the TA commands for TAG 1 and TAG 2 can be applied normally since the active BWP (BWP 1) is not associated with TAG 2. After the BWP switching, the active BWP becomes BWP 2, which is now associated with both TAG 1 and TAG 2. At this time, a new TA value associated with TAG 2 will be applied and it is of cause not the same as the TA value associated with TAG 1. In other words, if the terminal device 110 changes an active UL BWP after applying an adjustment for the uplink transmission timing, the terminal device 110 may assume a same absolute timing advance command value before and after the active UL BWP change within a TAG.

Some embodiments of applying the TA commands for multiple TAGs have been described above. In the following, some embodiments related to specific configurations related to configuration, indication, and/or capability for supporting multiple TAGs will be further provided.

In some embodiments, some methods and restrictions are provided for configuring multiple TAGs belonging to a serving cell of the terminal device.

In some embodiments, multiple TAGs may be needed in a MTRP mode. In some case, the MTRP mode may be configured per BWP, and the unified TCI state operation may be configured per BWP. In some embodiments, whether to follow the unified TCI state(s) for UL transmissions may also be configured per BWP, even per each channel or reference signal. Thus, not all BWPs in a cell need multiple TAGs, for which the applied TAG/TA value may require further selection. Therefore, in some embodiments, for a certain cell which is associated with multiple TAGs, one or more of the TAGs may be configured or applied for one or more BWPs (e.g., UL BWPs) configured with the MTRP mode.

In some embodiments, the plurality of TAGs associated with a cell for the terminal device 110 (the first cell) may be configured per BWP. For example, the terminal device 110 may receive configuration information indicating that which BWP is associated with which TAGs. One or more BWPs configured with the MTRP mode may be associated with two or more of the plurality of TAGs, and one or more other BWPs configured without the MTRP mode may be each associated with one of the plurality of TAGs.

FIG. 7 illustrates an example of association relationship 700 between BWPs and TAGs. In this example, it is assumed that Serving Cell x for the terminal device 110 is associated with two TAGs, TAG 1 and TAG 2. Among all the UL BWPs of Serving Cell x, UL BWP 2 is configured with a target MTRP mode and thus is associated with both of TAG 1 and TAG 2. The other UL BWPs are associated with one of the plurality of TAGs, for example, TAG 1.

In some embodiments, one of the plurality of TAGs may be configured to be associated with the BWP(s) supporting the MTRP mode. For example, TAG 2 in the example of FIG. 7 is configured to be applied for the BWP(s) supporting the MTRP mode.

In some embodiments, one TAG ID may be configured per cell, and one or more additional TAG IDs may be configured to the BWP(s) operating in the MTRP mode.

In some embodiments, more than one TAG may not be configured for the initial UL BWP. Generally, the initial UL BWP may not be used for MTRP operations.

In some embodiments, the plurality of TAGs may be configured per cell, as in the example of FIG. 4. The configuration information may further indicate that at least one of the plurality of TAGs is restricted from being applied for one or more BWPs configured without the MTRP mode. In an example, a first TAG may apply for all the UL BWPs in the serving cell, but one or more second TAGs do not apply for the UL BWP(s) without the MTRP mode. In some embodiments, if two or more TAGS are configured for the terminal device 110, the first TAG may be the one with the lowest or highest TAG ID, and the second TAG(s) may be the one(s) with the remaining higher TAG IDs or lower TAG IDs. If two TAGs are configured, the second TAG may be the one with the higher or lower TAG ID.

In some embodiments, the one or more second TAGs may be configured in a predefined information element (IE), for example, an IE specified as additionalTAG-ID. In some embodiments, the restriction of not applying the second TAG(s) means that the terminal device 110 may ignore the second TAG(s), the TA value(s) or TA command(s) associated therewith. In some embodiments, the restriction of not applying the second TAG(s) means that the terminal device 110 may not stop or start a timer (represented as timeAlignmentTimer) associated with the second TAG(s) or considered it as expired.

In some embodiments, different TAGs may be configured per BWP. That is, there may be one-to-one association relationship between the TAGs and the BWPs of the serving cell. For example, the configuration information for the terminal device may indicate that UL BWP 1 is associated with TAG 1, and UL BWP 2 is associated with BWP 2. With such configuration, in some embodiments, BWP switching in a cell may be used as TAG switching and thus TA value switching. The applied TA value may be a TA value for the TAG associated with the BWP after switching. In this case, some extra delay may be introduced to complete the BWP switching to handle the TAG change. On the other hand, it is convenient and easy for the management of both the BWPs and TAGs.

In some embodiments, there may be several cell groups or cell lists configured for the terminal device 110, including, but not limited to, common beam operations, simultaneous update of TCI state(s), spatial relations, and unified TCI state(s), for a list of component carriers (CCs) or BWPs, and there may be some overlapping issues between the lists of CCs or BWPs and the cells in the TAG(s). Those lists may be configured via e.g., RRC IE simultaneousTCI-UpdateList, simultaneousSpatial-UpdatedList, simultaneousU-TCI-UpdateList, and so on.

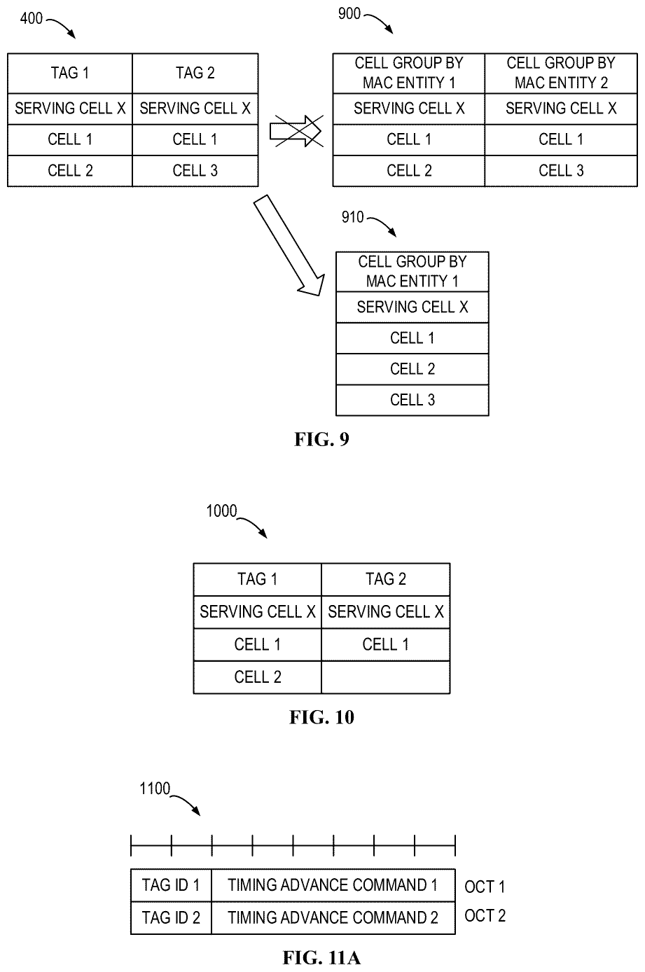

To address the overlapping issues, in some embodiments, if a cell is associated with a plurality of TAGs, this cell may not be in a same CC list for simultaneous TCI update, simultaneous spatial relation update, simultaneous unified TCI update, simultaneous UL TCI update as the cells associated with only one TAG. For example, if a first cell for the terminal device 110 is configured with the plurality of TAGs, the terminal device 110 may receive configuration information for a CC list for simultaneous TCI/spatial relation/unified TCI/UL TCI update, which indicate a list of cells that are all configured as associated with the plurality of TAGs, including the first cell. FIG. 8 illustrates an example configuration for the TAGs and CC lists. In this example, according to the configuration 400 of TAGs shown in FIG. 4, Serving Cell x of the terminal device 110 and Cell 1 are configured as associated with both TAG 1 and TAG 2. Thus, Serving Cell x and Cell 1 may be included in a same CC list 800 for simultaneous TCI update. If Cell 2 and Cell 3 are also to be configured for simultaneous TCI update, they may be configured in two separate CC lists. In other words, cells for simultaneous TCI/spatial relation/unified TCI/UL TCI update are cells configured with the same TAGs, for example, cells with the same number of TAGs, and same TAG IDs.

In some embodiments, the terminal device 110 may be configured with cell grouping, for example, via RRC IE CellGroupConfig, which is used to configure a master cell group (MCG) or secondary cell group (SCG). A cell group may comprise one MAC entity, a set of logical channels with associated radio link control (RLC) entities and of a primary cell (SpCell) and one or more secondary cells (SCells). There may be overlapping issues between the list(s) of cell grouping for MAC entities and the cells in TAG(s). To address such issues, in some embodiments, cell grouping for the MAC entities may be configured according to the configuration of the TAGs.

Specifically, if a serving cell of the terminal device 110 is associated with a plurality of TAGs, cells associated with those TAGs may be controlled a same MAC entity. Otherwise, if those cells are not controlled by the same MAC entity, TAG switching may require MAC entity switching, which may introduce large delay and complexity. In other words, a cell group for a MAC entity may not be configured per TAG. If the serving cell is associated with a plurality of TAGs, all cells associated with the plurality of TAGs may be configured in a same cell group via RRC IE CellGroupConfig or MAC-CellGroupConfig.

FIG. 9 illustrates a diagram of an example configuration for TAGs and cell groups by MAC entities in accordance with some embodiments of the present disclosure. In this example, according to the configuration 400 of TAGs, cell grouping 900 may be inappropriate because Cell 2 and Cell 3 cannot be in different MAC entities. Cell grouping 910 may be desirable, with all the cells associated with any one of TAG 1 and TAG 2 controlled by a same MAC entity (MAC Entity 1).

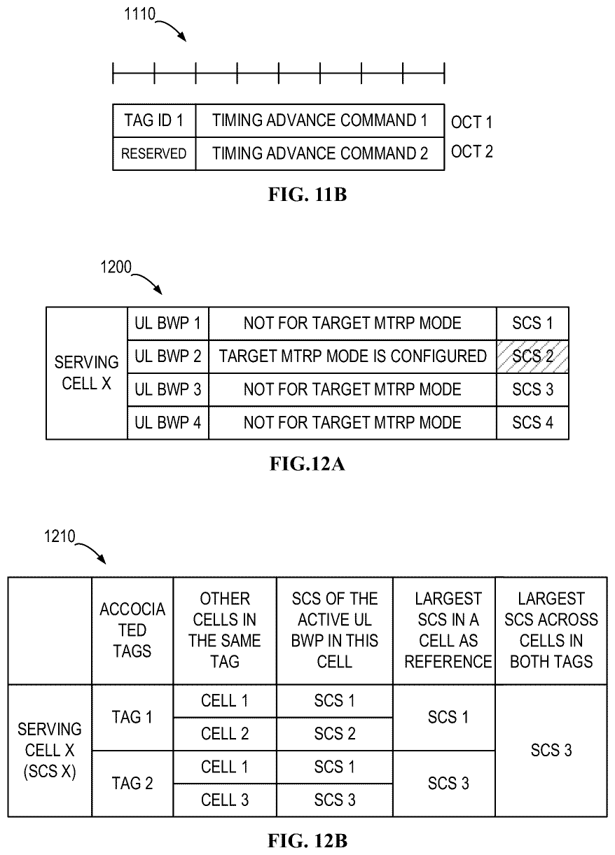

In some embodiments, in configuration of TAGs for cells, there may be some restrictions of cells configured with the MTRP mode (one or more BWPs of each of the cells configured with this mode). For example, if a cell(s) is not configured with the MTRP mode, the cell(s) may be configured to be associated with one TAG. One or more additional TAGs may be configured to be associated with other cell(s) configured with the MTRP mode. FIG. 10 illustrates a configuration 1000 of TAGs in accordance with some embodiments of the present disclosure.

In some embodiments, in configuration of TAGs for cells, there may be some restrictions for inter-cell operation. In the inter-cell MTRP case, or inter-cell mobility case, cell(s) with a different PCI than the serving cell can be configured or activated. If a plurality of TAGs are configured for the cell(s) with a different PCI, there will be extra complexity to maintain the TAs for all cells. In some embodiments, if a first cell for the terminal device 110 is configured with an inter-cell MTRP mode with a second cell, the total number of TAGs associated with the first cell and the second cell may be restricted, for example, as lower than or equal to a predefined number.

In some examples, the cell(s) with physical cell identity (PCI) different from a serving cell for a terminal device cannot be associated with the plurality of TAGs. In some examples, the total number of TAGs can be configured, activated, or maintained for the inter-cell MTRP may be lower than or equal to 2. In some examples, a plurality of TAGs may be configured separately among the cells with different PCI. For example, if there are two different TAGs, one is for the serving cell and the other is for the cell with a different PCI. In another example, two TAGs may be configured for the serving cell and one of the two TAGs may be configured for the cell with the different PCI. In this way, adjacent cells for the terminal device may not be associated with the same multiple PCIs, and the complexity in maintaining TAGs may be limited by restricting the total number of TAGs used among the cells for inter-cell MTRP mode.

In some embodiments, the terminal device 110 may be provided a value N_{TA,offset} of a TA offset for a serving cell by n-TimingAdvanceOffset for the serving cell. If the cell is configured to be associated with a plurality of TAGs, the terminal device 110 may receive information indicating a plurality of TA offset values for the cell, for example, multiple n-TimingAdvanceOffset values. The terminal device 110 may associate those TA offset values with the corresponding TAGs.

In some embodiments, the terminal device 110 may apply a one-to-one association for the TA offset value and the TAG, one TAG being associated with one TA offset value. Alternatively, or in addition, a TAG associated with a larger or largest TA offset value may be applied for an inter-cell operation. Alternatively, or in addition, the TAG associated with the larger or largest TA offset value may be applied for a cell(s) configured with eNB NR Dual Connection (EN-DC) or NR-Unlicensed. Alternatively, or in addition, the TAG associated with the larger or largest TA offset value may be applied for a cell(s) configured with a different full duplex mode.

In the case that a plurality of TAGs are configured, information indicating which TAGs are to be used or adjusted may be needed. In some embodiments, TAG ID may be indicated for or associated with UL transmissions, e.g., for Physical Random Access Channel (PRACH) transmission, Physical Uplink Control Channel (PUCCH) transmission, Physical Uplink Shared Channel (PUSCH) transmission, or Sounding Reference Signal (SRS) transmission. In some embodiments, an MAC CE may be transmitted to the termina device 110, containing a plurality of TA commands for the plurality of TAGs. In the MAC CE, the plurality of TA commands may be associated with a plurality of identities (TAG ID) of the plurality of TAGs. A TA command may indicate TA adjustment information for the corresponding TAG.

In some embodiments, the plurality of TAG IDs and a plurality of fields in a MAC CE may indicate the indexed value(s) TA used to control the amount of timing adjustment. In some examples, the TAG IDs for TA commands in one MAC CE may be configured for a same serving cell. FIG. 11A shows an example of a MAC CE 1100 used to indicate TA commands, each TA command being associated with corresponding TAG ID.

In some embodiments, in the case that two TAGs are configured, if a dedicated TAG is used for providing the second TA value, then only one TAG ID is needed. FIG. 11B shows an example of such a MAC CE 1110, where a reserved field is dedicated for providing the TA command for TAG2, and thus, TAG IDI for TAG 1 is included in the MAC CE.

In some embodiments, TA adjustment information for a second TAG may be indicated via one or more of the following: an absolute value, relative value, differential value with respect to the TA adjustment of a first TAG, information about whether to apply the same indicated TA adjustment of the first TAG, information about whether the terminal device should derive the TA adjustment of the second TAG based on the indicated TA adjustment of the first TAG and/or DL reference timing difference of the two TAGs.

In some embodiments, the configuration information for the plurality of TAGs may further indicate an association relationship between the plurality of TAGs and communication resources. TAG IDs may be indicated for or associated with the resources. In some examples, the resources may include any one or more of UL resources, beams UL transmissions, UL transmission occasions, such as PRACH, PUCCH, PUSCH or SRS resources, transmissions, or transmission occasions. In some examples, the resources may include one or more of DL resources, signals, or beams, such as Physical Downlink Control Channel, control resource sets (CORESETs), CORESET pools, CORESET groups, Synchronization Signal/Physical Broadcasting Channel (SS/PBCH blocks), Channel state information reference signal (CSI-RS) resource, Pathloss reference signal (PL-RS) and/or the like.

Alternatively, or in addition, the configuration information may further indicate an association relationship between the plurality of TAGs and TRPs. TAG IDs may be indicated for or associated with the TRPs. Alternatively, or in addition, the configuration information may further indicate an association relationship between the plurality of TAGs and TCI states and/or spatial relations. TCI states may include normal TCI states, unified TCI states or UL TCI states.

When the association relationship(s) is established, the signaling of changing abovementioned resources, beams, channels or others can be used as the signaling of switching TAs between the plurality of TAGs, and/or the signaling of the signaling of starting or stopping the respective TA timer(s) of the TAGs.

In some embodiments, in the case that a plurality of TAGs are configured, new UE capability may be needed. In some embodiments, the terminal device 110 may transmit, in any appropriate time, capability information indicating its capabilities related to TAG(s), to allow the network device to be aware of its capability on TAG configuration.

In some embodiments, the capability information may indicate whether the terminal device supports a plurality of TAGs for a cell, and/or whether the terminal device supports a plurality of TA commands, TA offsets, TA timers and/or DL reference timing for a cell, a Primary Cell (PCell), Secondary Cell (SCell), special Cell (SPCell), or Primary Secondary Cell (PSCell).

Alternatively, or in addition, the capability information may indicate the number of TAGs supported by the terminal device, and/or, the number of TA commands, the number of TA offsets, the number of TA timers, the number of DL reference timing for one cell, PCell, SCell, SPCell or PSCell supported by the terminal device.

Alternatively, or in addition, the capability information may indicate a combination of TAGs supported by the terminal device or the number of TAG combinations for one cell, PCell, SCell, SPCell or PSCell supported by the terminal device. Here, a TAG combination may indicate for example, TAG 1+TAG 2 or TAG 1+TAG 3 for a serving cell.

Alternatively, or in addition, the capability information may indicate the number of cells that can be configured with the plurality of TAGs, or more specifically, with the TA commands, TA offsets, TA timers, DL reference timing.

Alternatively, or in addition, the capability information may indicate whether the terminal device supports different TAGs (and/or TA commands, TA offsets, TA timers, DL reference timing) in adjacent cells, for example, in the serving cell and cells with a different PCI.

Alternatively, or in addition, the capability information may indicate a total number of TAGs (and/or TA commands, TA offsets, TA timers, DL reference timing) to be supported for the serving cell or for adjacent cells (for example, for both the serving cell and the cell with the different PCI).

Alternatively, or in addition, the capability information may indicate whether the terminal device supports different TAGs (and/or TA commands, TA offsets, TA timers, DL reference timing) simultaneously.

In some embodiments, the capability information may indicate the number of timing advance groups supported by the terminal device. In some embodiments, the capability information may indicate whether the terminal device supports enhanced uplink capabilities for intra-frequency Dual Active Protocol Stack (DAPS) handover.

In some embodiments, as mentioned above, a reference SCS may be needed, to determine the indicated TA value. In the case that a plurality of TAGs are configured, the reference SCS may be aligned among the TAGs.

In some embodiments, the reference SCS used to determine the indicated TA values for the TAGs may be based on those BWPs configured with the MTRP mode, and the reference SCS may be determined across all cells in the plurality of TAGs.

For example, the TA command value(s) may be determined relative to the largest SCS of the multiple active UL BWPs configured with the MTRP mode. For a certain Serving Cell x with four UL BWPs in an example 1210 of FIG. 12A, since UL BWP 2 is configured with the target MTRP mode, SCS 2 of UL BWP 2 may be used to determine the reference SCS.

In some embodiments, the reference SCS may be determined across the cells associated with the plurality of SCSs, to select the largest SCS to determine the TA value and thus UL transmission timing for the plurality of TAGs. As shown in FIG. 12B, the association between TAG 1, TAG 2 and the cells are the same as the example of FIG. 4. It is assumed that SCS 3>SCS1>SCS x. For each of Cell 1 and Cell 2, SCS to be used may be determined in a similar way as for Serving Cell x. For TAG 1, among SCS 1 for Cell 1 SCS x for Serving Cell x, and SCS 2 for Cell 2, the larger one, i.e., SCS 1, is selected. For TAG 2, among SCS 3 for Cell 3, SCS x for Serving Cell x, and SCS 2 for Cell 2, the larger one, i.e., SCS 3, is selected. The larger one between SCS 1 for TAG 1 and SCS 3 for TAG 2 is selected as the reference SCS.

Thus, in some embodiments, if a plurality of TAGs are associated with one serving cell, the reference SCS may be the same. That is, the multiple TA command values may be determined relative to the largest SCS of the multiple active UL BWPs configured in cells of multiple TAGs. In some embodiments, at least for the case that one MAC CE is used to indicate the plurality of TA adjustments (via TA commands), the same reference SCS may be used. In some examples, the TA command value(s) may be relative to the same reference SCS for the plurality of TAGs configured for one serving cell. In some embodiments, at least for one or more of the TAGs, such as a second TA value for a second TAG, the reference SCS may be determined as the largest SCS of the multiple active UL BWPs configured in cells of multiple TAGs.

Alternatively, a reference SCS may be determined from SCSs of BWPs of cells in one TAG, and one or more other TAGs may use this reference SCS. For example, if two TAGs are configured, the second TA value for the second TAG may be determined by applying the same reference SCS of the first TA. The reference SCS for a certain TAG may be selected as the large rest SCS of multiple active UL BWPs in the TAG.

In some embodiments, if a plurality of TAGs are associated with one serving cell, the reference SCS may be determined per TRP, or per TAG. That is, a plurality of reference SCSs may be determined for the plurality of TAGs, respectively. A reference SCS may be determined as in the example of FIG. 12A. Then a plurality of UL transmission timings (e.g., TA values) may be determined for the plurality of TAGs based on the plurality of reference SCSs, respectively. It is noted that a TA value associated with TAG 1 is used for transmission to a first TRP and a TA value associated with TAG 2 is used for transmission to a second TRP; thus, the reference SCS may be considered as decided per TRP.

Some example embodiments related to the configurations, indications, and/or device capabilities for supporting multiple TAGs are provided above.

In some embodiments, a plurality of timers associated with the plurality of TAGs are triggered, and thus performance of certain communication procedures relies on the timers are configured, to enable completion of those communication procedures.

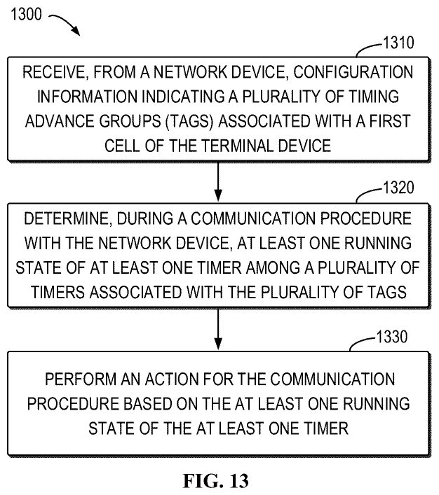

FIG. 13 shows a flowchart of an example communication method 1300 in accordance with some embodiments of the present disclosure. The method 1300 may be implemented by the terminal device to determine how TA commands are applied for UL timing. For the purpose of discussion, the method 1300 will be described with reference to FIG. 1, and the method 1300 may be implemented at the terminal device 110.

At block 1310, the terminal device 110 receives, from a network device, configuration information indicating a plurality of TAGs associated with a first cell of the terminal device 110.

The embodiments related to TA timers disused with reference to FIG. 13 may be combined with any other embodiments described for the TAG configurations, indications, and/or device capabilities in the above and/or any other embodiments described below for TA value alignment in the following.

According to the legacy method, one TAG is associated with one serving cell, and one timer (also referred to as “time alignment timer”) is configured for one TAG. Depending on whether the timer is running or not, different actions are expected for some communication procedures. If a plurality of TAGs are allowed for one serving cell, the conditions for the actions may need some updates.

At block 1320, the terminal device 110 determines, during a communication procedure with the network device, at least one running state of at least one timer among a plurality of timers associated with the plurality of TAGs. At block 1330, the terminal device 110 performs an action for the communication procedure based on the at least one running state of the at least one timer.

In the case that multiple TAGs are configured, there may be varied conditions related to their running state. For example, if two TAGs are configured, there are 4 possible conditions, including that both timers are running, a first timer is running but a second timer is not running, the second timer is running but the first timer is not running, or both the timers are not running. Considering the various possible conditions, the timer(s) considered in different communication procedures may be selected, so as to ensure that the terminal device 110 may behave correctly in the procedures, without performance loss.

In some embodiments, if the at least one timer is running, the terminal device 110 may determine that a first condition is met, and may perform a first action for the communication procedure. If the at least one timer is not running, the terminal device 110 may determine that a second condition is met, and may perform a second action for the communication procedure.

In some embodiments, the first condition may include that the timer(s) associated with at least one of the TAGs for a serving cell is running. In some embodiments, the first condition may include that the timer(s) associated with all TAGS for a serving cell is running. In some embodiments, the first condition may include that the timer(s) associated with a same TAG(s) as the UL resource(s) is associated with for a serving cell is running. In some embodiments, the first condition may include that the timer(s) associated with the same TAG(s) as the TCI state(s) is associated with for a serving cell is running. In some embodiments, the first condition may include that the timer(s) associated with the same TAG(s) as the CORESET(s) is associated with for a serving cell is running.

In some embodiments, the second condition may include that the timer(s) associated with at least one of multiple TAGs for a serving cell is not running. In some embodiments, the second condition may include that the timer(s) associated with all TAGS for a serving cell is not running. In some embodiments, the second condition may include that the timer(s) associated with the same TAG(s) as the UL resource(s) is associated with for a serving cell is not running. In some embodiments, the second condition may include that the timer(s) associated with the same TAG(s) as the TCI state(s) is associated with for a serving cell is not running. In some embodiments, the second condition may include that the timer(s) associated with the same TAG(s) as the CORESET(s) is associated with for a serving cell is not running.

The conditions can eliminate ambiguities for behaviors of the terminal device when a plurality of TAGs are configured for a serving cell. For example, if the first condition is not defined, the terminal device may proceed with follow-up actions when the uplink transmission is not ready, which may cause error case. If the second condition is not defined, the terminal device may not proceed with follow-up actions which can be carried out, which may cause extra delay.

In some embodiments, depending on the communication procedures, different conditions may be applied for different actions. In some embodiments, in a data transfer procedure, a running timer associated with a TAG of the serving cell is defined as the condition for processing DL and UL shared channel (SCH) data transfer. In the legacy method when one TAG is configured for a cell, the terminal device may find the cell for a HARQ feedback, determine the TAG associated with this cell, and check if the timer associated with this TAG is running. If the serving cell is associated with more than one TAG, improvements are needed.

In some embodiments, in a data transfer procedure, if the above first condition is met, the terminal device 110 may indicate a positive acknowledgement (ACK) to a DL reception. In some examples, for DL-SCH semi-persistent scheduling (SPS) deactivation, the first condition may include that the timer(s) associated with the same TAG(s) as the UL resource(s), TCI state(s), spatial relation(s), unified TCI state(s), and/or CORESET(s) for the HARQ feedback to be transmitted is running. In the examples of DL-SCH SPS deactivation, the terminal device 110 may indicate a positive acknowledgement to indicate the SPS deactivation to the physical layer.

In those examples, if the first condition is not defined as above, the terminal device may indicate positive ACK when the uplink transmission is not ready (e.g., the HARQ feedback is not able to be transmitted), which may cause error case. For example, if TAG 1 timer for HARQ feedback is not running, but TAG 2 timer is running, the terminal device 110 should not proceed the follow-up step(s).

In some examples, for UL-SCH UL Grant reception, if the MAC entity has a Cell-Radio Network Temporary Identifier (C-RNTI), a Temporary C-RNTI, or Configured Scheduling-RNTI (CS-RNTI), for each PDCCH occasion and when the first condition is met, the terminal device 110 may proceed the received UL grant, to use the UL grant in the data transfer procedure. In some examples, the first condition may specifically include that the timer(s) associated with at least one of multiple TAGs for a serving cell is running, or the timer(s) associated with all TAGS for a serving cell is running.

Proceeding the received UL grant may include any of the following: considering the NDI to have been toggled for the corresponding HARQ process regardless of the value of the NDI; starting or restarting the configuredGrantTimer for the corresponding HARQ process, if configured; stopping the cg-Retransmission Timer for the corresponding HARQ process, if running; stopping the cg-SDT-RetransmissionTimer, if running; delivering the uplink grant and the associated HARQ information to the HARQ entity; triggering activation of PDCP duplication for all configured RLC entities of the DRB; triggering configured uplink grant confirmation; store the uplink grant for this Serving Cell and the associated HARQ information as configured uplink grant; or initialising or re-initialising the configured uplink grant for this Serving Cell to start in the associated PUSCH duration and to recur according to rules for transmission and reception without dynamic scheduling.

In some embodiments, in a HARQ procedure, when one TAG is configured for a cell in the legacy method, the terminal device may find the cell for a HARQ feedback, determine the TAG associated with this cell, and check if the timer associated with this TAG is running. If the serving cell is associated with more than one TAG, improvements are also needed. In some embodiments, if the above second condition is preventing a physical layer to generate an acknowledgment in a transport block (TB). In some examples, for DL-SCH or UL-SCH, when a transmission takes place for the HARQ procedure, one or two (in case of downlink spatial multiplexing) TBs and the associated HARQ information are received from the HARQ entity, and if the second condition is met, the MAC entity may not instruct the physical layer to generate acknowledgement(s) of the data in this TB. In some examples, for slink-SCH (SL-SCH), if sidelink PUCCH configuration (sl-PUCCH-Config) is configured by RRC and if the second condition is met, for a PUCCH transmission occasion, the MAC entity may not instruct the physical layer to generate acknowledgement(s) of the data in this TB. In some examples, the second condition may include that the timer(s) associated with the same TAG(s) as the UL resource(s), TCI state(s), spatial relation(s), unified TCI state(s), and/or CORESET(s) for the HARQ feedback is to be transmitted is associated with for a serving cell is not running.

In some embodiments, in an activation or deactivation procedure of a secondary cell group (SCG), if the first condition is met, the terminal device 110 may perform the first action of activation of the SCG according to a timing for direct SCG activation. If the second condition is met, the terminal device 110 may perform the second action of suspending the activation of the SCG. In some embodiments, the second action may include indicating that a random access procedure is needed for SCG activation. In some examples, if upper layers indicate that SCG is activated, and if the first condition is met, the terminal device 110 may activate the SCG according to the timing for direct SCG activation. In some examples, the first condition may include that the timer(s) associated with all PTAGs for a serving cell is running. Alternatively, the first condition may include that timer(s) associated with at least one of multiple PTAGs for a serving cell is running. In some examples, if upper layers indicate that SCG is activated, and if the first condition is met, the terminal device 110 may indicate to upper layers that a Random Access Procedure is needed for SCG activation. In some examples, the second condition may include that the timer(s) associated with at least one of multiple PTAGs for a serving cell is not running. Alternatively, the second condition may include that the timer(s) associated with all PTAGs for a serving cell is not running. In the case of activation or deactivation of SCG, without carefully defining the first condition, the terminal device may activate the SCG by mistake. In addition, without carefully defining the second condition, the terminal device may trigger a redundant random access procedure.

In some embodiments, in a random access (RA) procedure, when one TAG is configured for a cell in the legacy method, the terminal device may determine the PTAG and check if the corresponding TA timer is running. In the cases where a plurality of TAGs are configured for a cell, there may be two or more PTAGs (and/or two or more corresponding timers), improvements are also needed. In some embodiments, in the RA procedure, such as in a two-step RA procedure, if the above first condition is met, the terminal device 110 may consider the RA procedure as successful completed. If the above second condition is met, the terminal device 110 may determine whether a timing advance command is received.

In a two-step RA procedure, a first message (MSGA) is transmitted from the terminal device to a network device. The terminal device may then receive a second message (MSGB) from the network device as a Random Access Response. In some examples, once the MSGA preamble is transmitted, regardless of the possible occurrence of a measurement gap, the MAC entity, if notification of a reception of a PDCCH transmission of the SpCell is received from lower layers, if the C-RNTI MAC CE was included in MSGA, if the first condition is met, and if the PDCCH transmission is addressed to the C-RNTI and contains a UL grant for a new transmission, the MAC entity may consider this Random Access Response reception successful. In this case, the MAC entity can stop a reception window for MSGB (msgB-ResponseWindow), and consider this Random Access procedure successfully completed. In some examples, the first condition may specifically include that the timer(s) associated with at least one of multiple PTAGs is running, or the timer(s) associated with all PTAGs is running. In some examples, if the second condition is met, and if a downlink assignment has been received on the PDCCH for the C-RNTI and the received TB is successfully decoded, and if the MAC protocol data unit (PDU) contains the Absolute Timing Advance Command MAC CE, the terminal device 110 may process the received Timing Advance Command. In this case, the terminal device may further consider this Random Access Response reception successful, stop the msgB-Response Window, and consider this Random Access procedure successfully completed and finish the disassembly and demultiplexing of the MAC PDU. In the case of RA procedure, if the first condition is not carefully defined, the terminal device may consider the MSGB received successfully by mistake. If the second condition is not carefully defined, the terminal device may trigger redundant random access procedure.

In some embodiments, TA value alignment within a cell is proposed, to allow performance of certain communication procedures.

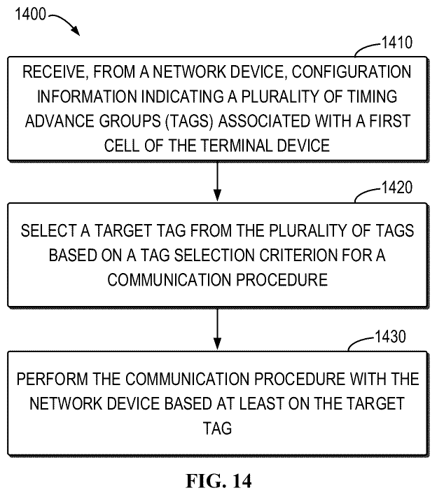

FIG. 14 shows a flowchart of an example communication method 1400 implemented in accordance with some embodiments of the present disclosure. The method 1400 may be implemented by the terminal device to determine how TA commands are applied for UL timing. For the purpose of discussion, the method 1400 will be described with reference to FIG. 1, and the method 1400 may be implemented at the terminal device 110.

At block 1410, the terminal device 110 receives, from a network device, configuration information indicating a plurality of TAGs associated with a first cell of the terminal device 110.

The embodiments related to TA value alignment disused with reference to FIG. 14 may be combined with any other embodiments described above for the TAG configurations, indications, device capabilities, and/or TA timers.

At block 1420, the terminal device 110 selects a target TAG from the plurality of TAGs based on a TAG selection criterion for a communication procedure.

According to the legacy method, one TAG is associated with one serving cell. Thus, a TA value of the same TAG of the serving cell is used to determine parameters for some communication procedures. If a plurality of TAGs are allowed for one serving cell, TA value may need to be aligned based on certain TAG selection criterion for a communication procedure. In some embodiments, for a serving cell associated with a plurality of TAGS, TA applied for some communication procedures is selected from a plurality of TAs of the plurality of TAGs according to a TAG selection criterion.

In some embodiments, the TAG selection criterion may be based on a plurality of identities of the plurality of TAGs. Alternatively, or in addition, the TAG selection criterion may be based on a plurality of TA values of the plurality of TAGs. Alternatively, or in addition, the TAG selection criterion may be based on a plurality of TA offsets (e.g., N_{TA,offset}), TA timers, DL reference timings of the plurality of TAGs. Alternatively, or in addition, the TAG selection criterion may be based on a first association relationship between BWPs and the plurality of TAGs. In some embodiments, if a BWP configured with a SL operation, the TAG associated with this BWP may be selected as the target TAG. In some embodiments, the TAG selection criterion may be based on which TAG is updated most recently by a TA command or an absolute TA command. In some embodiments, the TAG selection criterion may be based on which TAG is applied most recently for the latest UL transmissions.

Alternatively, or in addition, the TAG selection criterion may be based on a second association relationship between at least one TRP and the plurality of TAGs. In some examples, a target TRP may include a predefined TRP, an indicated reference TRP, a main TRP, a TRP corresponding to a CORESET pool, a TRP corresponding to a transmission configuration indicator (TCI) state, or a TRP corresponding to a resource. A TAG associated with such a target TRP may be selected as the target TAG. Alternatively, or in addition, the TAG associated with the target MTRP mode is not selected as the target TAG. Alternatively, or in addition, the TAG selection criterion may be based on a third association relationship between at least one CORESET and the plurality of TAGs. Alternatively, or in addition, the TAG selection criterion may be based on a fourth relationship between a set of reference signals available for BFR and the plurality of TAGs.

Some additional or alternative TAG selection criterion may be further provided in the following embodiments, depending on the specific communication procedures.

At block 1430, the terminal device 110 performs the communication procedure with the network device based at least on the target TAG.

In some embodiments, in a supplementary UL (SUL) operation procedure, a TA applied for SUL and normal UL (NUL) may be the same. If the terminal device 110 is configured with two UL carriers (SUL and NUL) for a serving cell, at least a same TA offset value N_{TA,offset} may apply to both carriers. The at least one same TA offset may be the TA offset associated with a target TAG with the lowest or highest TAG ID, or a target TAG with the smallest or largest TA offset value. In some examples, if two or more TA offset values are configured in one TAG, a further selection can be done by choosing the smallest or largest TA offset value.

In some embodiments, as an alternative, in the SUL operation, the cell or BWP configured with SUL may not be configured with a plurality of TAGs, to allow the TA alignment. In some embodiments, in the SUL operation, it may be configured that the TA applied to SUL may be determined according to the association relationship between TAGs and TRPs. For example, the applied to SUL may be aligned with the TA associated with a target TRP. This target TRP can be a predefined or a indicated reference TRP, or a main TRP. In some examples, this TRP may also be represented by an index of the CORESET pool (CORESETPoolIndex), an index of a TCI state, and/or a resource index. In some embodiments, since SUL is not using beam for transmission, a unified TCI framework may not apply to SUL. The beam application timing may also not be applied to SUL.

By correctly selecting a TA to be applied for SUL, it may increase the chance to successfully transmit SUL.

In some embodiments, in a sounding procedure between component carriers, if the target TAG is selected, the terminal device 110 may determine, based on the target TAG, a set of carriers from which a sounding procedure is available to be switched to a further carrier. The set of carriers may at least in the same TAG, i.e., target TAG. In some examples, for a carrier of a serving cell c1 with slot formats comprised of DL and UL symbols, not configured for PUSCH or PUCCH transmission, denote c₂ as the corresponding carrier of a serving cell whose UL transmissions are temporarily suspended as signalled by higher layer parameter srs-SwitchFromServCellIndex and srs-SwitchFromCarrier. Define the set S(c2)={c₂, s₁(c₂) . . . . s_{N-1}(c₂)} as the set of carriers of serving cells that each carrier meets one of the following conditions: sᵢ(c₂) is in the same band and at least in one same TAG as c₂; and sᵢ(c₂) is a carrier of inter-band CA with c₂ and sᵢ(c₂) is indicated through the capability signalling ImpactedBands-SRS-CS-v17 to be affected by the SRS switch from c₂ to c₁, where 1≤i≤N−1. The same TAG may be the TAG with the lowest or highest TAG ID, the TAG with the smallest or largest TA values. Alternatively, sᵢ(c₂) is in the same band and associated with the same two TAGs as c₂. Alternatively, the cell or BWP configured with SRS switching between CCs (e.g., with srs-SwitchFromServCellIndex and srs-SwitchFromCarrier) may not be configured with the plurality of TAGs. Through those embodiments, more carriers sᵢ(c₂) that sounding can be switched from may be added in the set of carriers.

In some embodiments, in a sidelink communication procedure, resources may be allocated for SL communications. For SL resource allocation in time domain, with the target TAG determined, the terminal device 110 may determine a TA value associated with the target TAG; and determine a sidelink resource allocated for the terminal device 110 based on the determined TA value. The time main position of the allocated resource may be determined as: time domain position by

$${T}_{DL} - \frac{{T}_{TA}}{2} + {K}_{SL} \times {T}_{slot} ,$$

where T_{DL} is the starting time of the downlink slot carrying the corresponding DCI, T_{TA} is the timing advance value corresponding to the TAG of the serving cell on which the DCI is received and K_{SL} is the slot offset between the slot of the DCI and the first sidelink transmission scheduled by DCI and Tₛₗₒₜ is the SL slot duration. In some examples, in sidelink resource allocation mode 1 and for sidelink dynamic grant and sidelink configured grant type 2, the slot of the first sidelink transmission scheduled by the DCI is the first SL slot of the corresponding resource pool that starts not earlier than

$${T}_{DL} - \frac{{T}_{TA}}{2} + {K}_{SL} \times {T}_{slot} .$$

In some examples, the target TAG whose TA value is used may be selected as the TAG with the lowest or highest TAG ID, the TAG with the smallest or largest TA values, the TAG one associated with the same CORESET.

Alternatively, in some embodiments, the cell or BWP configured with sidelink operation may not be configured with a plurality of TAGs, to avoid the confusion in sidelink resource allocation.

In some embodiments, a beam failure recovery (BFR) procedure, especially in MTRP BFR case, after beam failure, usually a new reference signal (RS) for BFR (represented as q_new) is selected. There is a possibility that the new reference signal may not apply a plurality of TAGs. Therefore, it needs to define rules to select TAGs applied after beam failure, so that the terminal device can correctly send a BFR request (BFRQ) and other UL signals or channels.

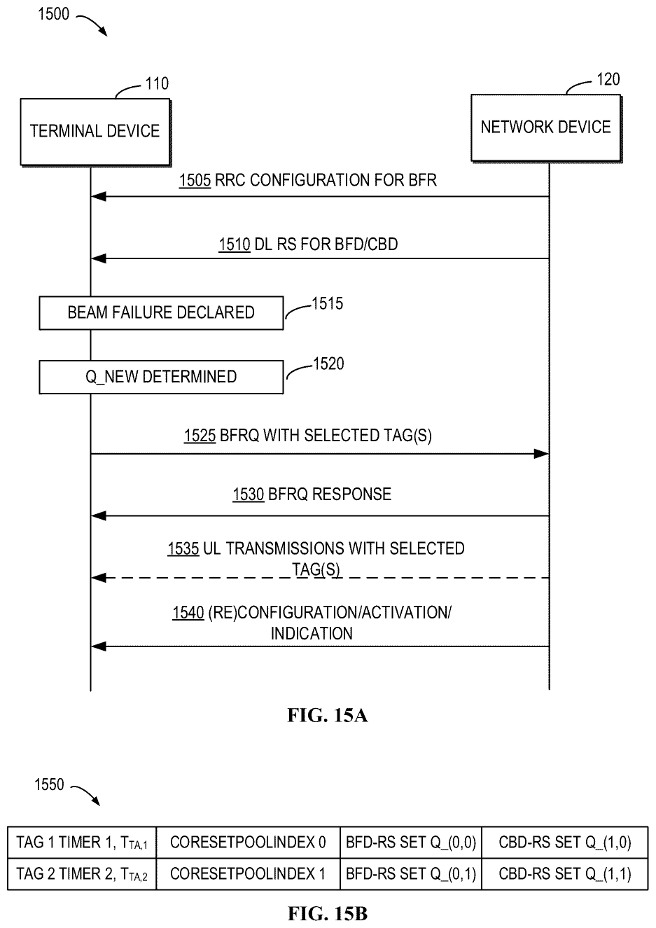

For better understanding, FIG. 15A illustrates an example BFR procedure between the terminal device 110 and the network device 120. During the BFR procedure, the network device 120 transmits 1505 a RRC configuration for BFR and transmits 1510 a set of DL RSs for beam failure detection (BFD) and/or candidate beam detection (CBD), referred to as BFD-RS and CBD-RS.

If the terminal device 110 declares 1515 beam failure, it selects 1520 a new reference signal (q_new) from the set of BFD-RS and CBD-RS. The terminal device 110 then transmits 1525 a BFRD with a selected TAG(s). The network device 120 transmits 1530 a BFRQ response to the terminal device 110. The terminal device 110 then performs 1535 UL transmission with the selected TAG(s) to the network device 120. Further, the network device 120 can perform 1540 reconfiguration, activation, and/or indication of TAGs and/or other information to the terminal device 110.

In some embodiments, it is proposed to associate the plurality of TAGs with respective reference signals in the BFD-RS set and/or CBD-RS set. FIG. 15B illustrates an example table 1550 showing an association between TAG, resource pool, and RSs for BFR. In this example, consider there are four reference signal sets, represented as q_(0,0), q_(0,1), q_(1,0) and q_(1,1). q_(0,0) and q_(0,1) are two BFD-RS sets for two TRPs respectively, q_(1,0) and q_(1,1) are two CBD-RS sets for two TRPs respectively. As shown in FIG. 15B, q_(0,0) is associated with q_(1,0), q_(0,1) is associated with q_(1,1); RSs in q_(0,0) and q_(1,0) are associated with the same TAG, i.e., TAG 1; and RSs in q_(0,1) and q_(1,1) are associated with the same TAG, i.e., TAG 2. Alternatively, in other examples, RSs in q_(0,0) and q_(1,1) may be associated with the same TAG; and RSs in q_(0,1) and q_(1,0) are associated with the same TAG.

With the association, after a BFD operation is failed (for example, beam failure is declared), and a new reference signal, q_new, is determined, a TAG associated with the selected reference signal (q_new) may be selected with the target TAG, and the TA of the target TAG associated with the selected reference signal may be applied for a BFD operation, for example, for transmitting the BFRQ with the selected TAG (or its TA). In some embodiments, the terminal device 110 may stop the TA timer of the TAG associated with the failed TRP or BFD-RS set. In some embodiments, the terminal device 110 may trigger a random access procedure to acquire a new TA for the selected target TAG. In some embodiments, if a plurality of TRPs being associated with the plurality of TAGs are failed, the terminal device 110 may stop the TA timer(s) of the plurality of TAGs. The applied TA is then 0. Furthermore, the terminal device 110 may trigger a random access procedure to acquire new Tas for the plurality of TAGs, respectively.

In some examples, a default TAG may be selected and the selection is as introduced before. In some examples, the TA for transmitting the BFRQ may be set to 0.

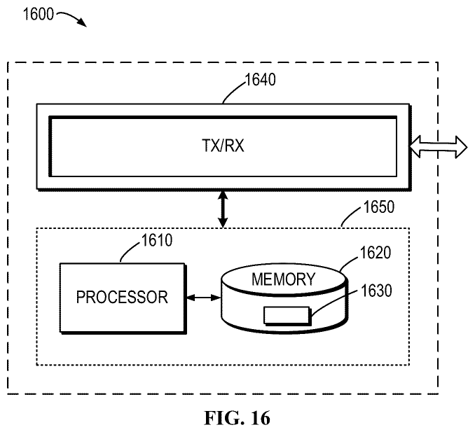

FIG. 16 is a simplified block diagram of a device 1600 that is suitable for implementing embodiments of the present disclosure. The device 1600 can be considered as a further example implementation of the terminal device 110 or the network device 120 as shown in FIG. 1. Accordingly, the device 1600 can be implemented at or as at least a part of the terminal device 110 or the network device 120.

As shown, the device 1600 includes a processor 1610, a memory 1620 coupled to the processor 1610, a suitable transmitter (TX)/receiver (RX) 1640 coupled to the processor 1610, and a communication interface coupled to the TX/RX 1640. The memory 1610 stores at least a part of a program 1630. The TX/RX 1640 is for bidirectional communications. The TX/RX 1640 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1630 is assumed to include program instructions that, when executed by the associated processor 1610, enable the device 1600 to operate in accordance with the embodiments of the present disclosure, as discussed herein with reference to FIGS. 1 to 6. The embodiments herein may be implemented by computer software executable by the processor 1610 of the device 1600, or by hardware, or by a combination of software and hardware. The processor 1610 may be configured to implement various embodiments of the present disclosure. Furthermore, a combination of the processor 1610 and memory 1620 may form processing means 1650 adapted to implement various embodiments of the present disclosure.

The memory 1620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1620 is shown in the device 1600, there may be several physically distinct memory modules in the device 1600. The processor 1610 may be of any type suitable to the local technical network, and may include one or more of general purpose computers, special purpose computers, microprocessors, digital signal processors (DSPs) and processors based on multicore processor architecture, as non-limiting examples. The device 1600 may have multiple processors, such as an application specific integrated circuit chip that is slaved in time to a clock which synchronizes the main processor.

In some embodiments, a communication device (for example, a terminal device) comprises a circuitry configured to: receive, at a terminal device and from a network device, configuration information indicating a plurality of timing advance groups (TAGs) associated with a first cell of the terminal device; determine, during a communication procedure with the network device, at least one running state of at least one timer among a plurality of timers associated with the plurality of TAGs; and perform an action for the communication procedure based on the at least one running state of the at least one timer.

In some embodiments, at least one timer comprises one of the following: the plurality of timers associated with the plurality of TAGs, at least one TAG of the plurality of TAGs associated with an uplink (UL) resource, at least one TAG of the plurality of TAGs associated with a transmission configuration indicator (TCI) state, at least one TAG of the plurality of TAGs associated with a spatial relation, at least one TAG of the plurality of TAGs associated with a control resource set (CORESET), one or more primary timing advance groups (PTAGs) comprised in the plurality of TAGs, or at least one of the one or more PTAGs.

In some embodiments, at least one of the UL resource, the TCI state, the spatial relation, or the CORESET is configured for a hybrid automatic repeat request (HARQ) feedback to be transmitted in the communication procedure.

In some embodiments, the circuitry is further configured to perform the action for the communication procedure by: in accordance with a determination that the at least one timer is running, determining that a first condition is met, and performing a first action for the communication procedure; and in accordance with a determination that the at least one timer is not running, determining that a second condition is met, and performing a second action for the communication procedure.

In some embodiments, the communication procedure comprises a data transfer procedure, and the first action comprises transmission of a positive acknowledgement to a downlink (DL) reception.

In some embodiments, the DL reception comprises an indication of semi-persistent scheduling (SPS) deactivation.

In some embodiments, the communication procedure comprises a data transfer procedure, and the first action comprises use of an UL grant in the data transfer procedure.

In some embodiments, the communication procedure comprises a HARQ procedure, and the second action comprises preventing a physical layer to generate an acknowledgment in a transport block (TB).

In some embodiments, the communication procedure comprises an activation or deactivation procedure of a secondary cell group (SCG), and the first action comprises activation of the SCG according to a timing for direct SCG activation, and the second action comprises suspending the activation of the SCG.

In some embodiments, the second action comprises indicating that a random access procedure is needed for SCG activation.

In some embodiments, the communication procedure comprises a random access (RA) procedure, and the first action comprises successful completion of the RA procedure, and the second action comprises a determination of whether a timing advance command is received.

In some embodiments, the RA procedure is of a 2-step RA type, and the first and second actions are performed for a reception of a RA response in the RA procedure.

In some embodiments, the first cell is configured with a first bandwidth parts (BWP) configured with a multi-transmission reception point (MTRP) mode and a second BWP configured without the MTRP mode, and the configuration information further indicates that the first BWP is associated with two or more of the plurality of TAGs, and the second BWP is associated with one of the plurality of TAGs.

In some embodiments, the first cell is configured with a first BWP configured with a multi-transmission reception point (MTRP) mode and a second BWP configured without the MTRP mode, and the configuration information further indicates that at least one of the plurality of TAGs is restricted from being applied for the second BWP.

In some embodiments, the first cell is configured with a first BWP configured with a multi-transmission reception point (MTRP) mode and a second BWP configured without the MTRP mode, and the configuration information further indicates that the first BWP is associated with a first TAG of the plurality of TAGs and the second BWP is associated with a second TAG of the plurality of TAGs.

In some embodiments, the circuitry is further configured to: receive, from the network device, further configuration information indicating a component carrier (CC) list for simultaneous TCI update, the CC list comprising at least one cell configured as associated with the plurality of TAGs, and the at least one cell comprising the first cell.

In some embodiments, the circuitry is further configured to: configure a cell group for a media access control (MAC) entity, the first cell group comprising at least one cell configured as associated with at least one of the plurality of TAGs, and the at least one cell comprising the first cell.

In some embodiments, the first cell is configured with a MTRP mode.

In some embodiments, the first cell is configured with an inter-cell MTRP mode with a second cell, and a total number of TAGs associated with the first cell and the second cell is lower than or equal to a predefined number.

In some embodiments, the second cell is configured to be associated with the plurality of TAGs.

In some embodiments, the circuitry is further configured to: receive, from the network device, information indicating a plurality of timing advance (TA) offset values for the first cell; and associating the plurality of TA offset values with the plurality of TAGs.

In some embodiments, the circuitry is further configured to: apply one of the plurality of TAGs based on the plurality of TA offset values.

In some embodiments, the circuitry is further configured to apply one of the plurality of TAGs by: applying a TAG associated with a largest TA offset value for at least one of the following: an inter-cell operation, a cell configured with a dual connection, a cell configured with an unlicensed spectrum, or a cell configured with a different full duplex mode.

In some embodiments, the circuitry is further configured to: receive, from the network device, a MAC control element (CE) containing a plurality of TA commands for the plurality of TAGs, the plurality of TA commands being associated with a plurality of identities of the plurality of TAGs in the MAC CE.

In some embodiments, the configuration information further indicates an association relationship between the plurality of TAGs and at least one of the following: resources, TRPs, TCI states, or spatial relations. In some embodiments, the circuitry is further configured to: receive, from the network device, a switching command, the switching command indicating at least one of the following: switching from a first resource to a second resource, switching from a first TRP to a second TRP, switching from a first TCI state to a second TCI state, or switching from a first spatial relation to a second spatial relation; and in response to the switching command, perform at least one of the following: switching from a first TA value of a first TAG associated with at least one of the first resource, the first TRP, the first TCI state, or the first spatial relation to a second TA value of the first TAG associated with at least one of the second resource, the second TRP, the second TCI state, or the second spatial relation, stopping a first timer associated with the first TAG, or starting a second timer associated with the second TAG.

In some embodiments, the circuitry is further configured to: transmit, to the network device, capability information indicating at least one of the following: whether the terminal device supports a plurality of TAGs for a cell, the number of TAGs supported by the terminal device, a combination of TAGs supported by the terminal device, the number of cells that can be configured with the plurality of TAGs, whether the terminal device supports different TAGs in adjacent cells, a total number of TAGs to be supported for the cell or for adjacent cells, or whether the terminal device supports different TAGs simultaneously.

In some embodiments, the circuitry is further configured to: determine, from a plurality of BWPs of the first cell, at least one BWP configured with a MTRP mode; determine a first reference subcarrier spacing (SCS) from at least one SCS of the at least one determined BWP of the first cell; and determining an UL transmission timing for at least one of the plurality of TAGs based at least in part on the first reference SCS.

In some embodiments, the circuitry is further configured to: determine a second reference SCS at least from at least one SCS of at least one cell associated with at least a first TAG of the plurality of TAGs; and determine, based at least in part on the second reference SCS, a plurality of UL transmission timings for the plurality of TAGs.

In some embodiments, the circuitry is further configured to determine the second reference SCS by: determining the second reference SCS from a plurality of SCSs of a plurality of BWPs configured for cells associated with the plurality of TAGs.

In some embodiments, the circuitry is further configured to determine the plurality of UL transmission timings by: receiving, from the network device, a MAC control element (CE) containing a plurality of TA commands for the plurality of TAGs; and in response to the MAC CE, determining the plurality of UL transmission timings for the plurality of TAGS based at least in part on the second reference SCS and the plurality of TA commands.

In some embodiments, the circuitry is further configured to: determine a plurality of reference SCSs for the plurality of TAGs, respectively; and determine a plurality of UL transmission timings for the plurality of TAGs based on the plurality of reference SCSs, respectively.

In some embodiments, the plurality of TAGs comprises two TAGs.

In some embodiments, a communication device (for example, a terminal device) comprises a circuitry configured to: receive, at a terminal device and from a network device, configuration information indicating a plurality of timing advance groups (TAGs) associated with a first cell of the terminal device; receive, from the network device, a plurality of timing advance (TA) commands for the plurality of TAGs; determine a start time point for the plurality of TAGs, the start time point indicating when the plurality of TA commands are to be applied; and in accordance with a determination that an active BWP of the first cell is configured with a multi-transmission reception point (MTRP) mode, apply the plurality of TA commands from the determined start time point.

In some embodiments, the circuitry is further configured to determine the start time point by: determining a plurality of values for a predetermined parameter for calculating the start time point based on corresponding bandwidth part (BWP) related information in the plurality of TAGs; selecting one of the plurality of values for the predetermined parameter; and determining the start time point based on the selected value for the predetermined parameter.

In some embodiments, the circuitry is further configured to: in accordance with a determination that an active BWP of the first cell is configured with an MTRP mode, apply the plurality of TA commands from the determined start time point.

In some embodiments, the circuitry is further configured to: in accordance with a determination that the terminal device switches from a first BWP to a second BWP before the start time point, in accordance with a determination that the second BWP is associated with a first TAG, determine a first TA value for the first TAG based on a first TA command for the first TAG and a reference SCS of the second BWP; and in accordance with a determination that the second BWP is not associated with the second TAG and the first BWP is associated with the second TAG, determine a second TA value for the second TAG based on a second TA command for the second TAG and a reference SCS of the first BWP.

In some embodiments, the circuitry is further configured to: determine a plurality of TA values for the plurality of TAGs by applying the plurality of TA commands, respectively; in accordance with a determination that the terminal device switches from a first BWP to a second BWP after the start time point, maintain at least one of the plurality of TA values for at least one of the plurality of TAGs.

In some embodiments, the plurality of TAGs comprises two TAGs.

In some embodiments, a communication device (for example, a terminal device) comprises a circuitry configured to: receive, at a terminal device and from a network device, configuration information indicating a plurality of timing advance groups (TAGs) associated with a cell for the terminal device; selecting a target TAG from the plurality of TAGs based on a TAG selection criterion for a communication procedure; and perform the communication procedure with the network device based at least on the target TAG.

In some embodiments, the TAG selection criterion is based on at least one of the following: a plurality of identities of the plurality of TAGs, a plurality of timing advance (TA) values of the plurality of TAGs, a first association relationship between bandwidth parts (BWPs) and the plurality of TAGs, a second association relationship between at least one transmission reception point (TRP) and the plurality of TAGs, a third association relationship between at least one control resource set (CORESET) and the plurality of TAGs, or a fourth relationship between a set of reference signals available for beam failure recovery (BFR) and the plurality of TAGs.

In some embodiments, in the first association relationship, a BWP associated with the target TAG comprises a BWP configured with a sidelink operation.

In some embodiments, in the second association relationship, a TRP associated with the target TAG comprises one of the following: a predefined TRP, an indicated reference TRP, a main TRP, a TRP corresponding to a CORESET pool, a TRP corresponding to a transmission configuration indicator (TCI) state, or a TRP corresponding to a resource.

In some embodiments, the communication procedure comprises a supplementary uplink (SUL) operation procedure, and the circuitry is further configured to perform the communication procedure by: applying, during the SUL operation procedure, a TA value of the target TAG.

In some embodiments, the communication procedure comprises a sounding procedure, and the circuitry is further configured to perform the communication procedure by: determining, based on the target TAG, a set of carriers from which a sounding procedure is available to be switched to a further carrier, the set of carriers being at least in the same target TAG.

In some embodiments, the communication procedure comprises a sidelink communication procedure, and the circuitry is further configured to perform the communication procedure by: determining a TA value associated with the target TAG; and determining a sidelink resource allocated for the terminal device based on the determined TA value.

In some embodiments, the communication procedure comprises a beam failure recovery (BFR) procedure, and the target TAG comprises a TAG associated with a reference signal selected from a set of reference signals for BFR, the circuitry is further configured to determine a TA value of the target TAG; and apply the TA value for a beam failure detection (BFD) operation based on the selected reference signal.

In some embodiments, the circuitry is further configured to: in accordance with a determination that the BFD operation is failed, stop a timer associated with the target TAG; and trigger a random access procedure to request a further TA value for the target TAG.

In some embodiments, the BFR procedure is performed for a plurality of TRPs, the plurality of TRPs being associated with the plurality of TAGs, and the circuitry is further configured to: in accordance with a determination that BFD operations with the plurality of TRPs are failed, stop a plurality of timers associated with the plurality of TAGs; and trigger a plurality of random access procedures to request respective TA values for the plurality of TAGs.

In some embodiments, the plurality of TAGs comprises two TAGs.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a communication method comprises: receiving, at a terminal device and from a network device, configuration information indicating a plurality of timing advance groups (TAGs) associated with a first cell of the terminal device; determining, during a communication procedure with the network device, at least one running state of at least one timer among a plurality of timers associated with the plurality of TAGs; and performing an action for the communication procedure based on the at least one running state of the at least one timer.

In some embodiments, at least one timer comprises one of the following: the plurality of timers associated with the plurality of TAGs, at least one TAG of the plurality of TAGs associated with an uplink (UL) resource, at least one TAG of the plurality of TAGs associated with a transmission configuration indicator (TCI) state, at least one TAG of the plurality of TAGs associated with a spatial relation, at least one TAG of the plurality of TAGs associated with a control resource set (CORESET), one or more primary timing advance groups (PTAGs) comprised in the plurality of TAGs, or at least one of the one or more PTAGs.

In some embodiments, at least one of the UL resource, the TCI state, the spatial relation, or the CORESET is configured for a hybrid automatic repeat request (HARQ) feedback to be transmitted in the communication procedure.

In some embodiments, performing the action for the communication procedure comprises: in accordance with a determination that the at least one timer is running, determining that a first condition is met, and performing a first action for the communication procedure; and in accordance with a determination that the at least one timer is not running, determining that a second condition is met, and performing a second action for the communication procedure.

In some embodiments, the communication procedure comprises a data transfer procedure, and the first action comprises transmission of a positive acknowledgement to a downlink (DL) reception.

In some embodiments, the DL reception comprises an indication of semi-persistent scheduling (SPS) deactivation.

In some embodiments, the communication procedure comprises a data transfer procedure, and the first action comprises use of an UL grant in the data transfer procedure.

In some embodiments, the communication procedure comprises a HARQ procedure, and the second action comprises preventing a physical layer to generate an acknowledgment in a transport block (TB).

In some embodiments, the communication procedure comprises an activation or deactivation procedure of a secondary cell group (SCG), and the first action comprises activation of the SCG according to a timing for direct SCG activation, and the second action comprises suspending the activation of the SCG.

In some embodiments, the second action comprises indicating that a random access procedure is needed for SCG activation.

In some embodiments, the communication procedure comprises a random access (RA) procedure, and the first action comprises successful completion of the RA procedure, and the second action comprises a determination of whether a timing advance command is received.

In some embodiments, the RA procedure is of a 2-step RA type, and the first and second actions are performed for a reception of a RA response in the RA procedure.

In some embodiments, the first cell is configured with a first bandwidth parts (BWP) configured with a multi-transmission reception point (MTRP) mode and a second BWP configured without the MTRP mode, and the configuration information further indicates that the first BWP is associated with two or more of the plurality of TAGs, and the second BWP is associated with one of the plurality of TAGs.

In some embodiments, the first cell is configured with a first BWP configured with a multi-transmission reception point (MTRP) mode and a second BWP configured without the MTRP mode, and the configuration information further indicates that at least one of the plurality of TAGs is restricted from being applied for the second BWP.

In some embodiments, the first cell is configured with a first BWP configured with a multi-transmission reception point (MTRP) mode and a second BWP configured without the MTRP mode, and the configuration information further indicates that the first BWP is associated with a first TAG of the plurality of TAGs and the second BWP is associated with a second TAG of the plurality of TAGs.

In some embodiments, the method further comprises: receiving, from the network device, further configuration information indicating a component carrier (CC) list for simultaneous TCI update, the CC list comprising at least one cell configured as associated with the plurality of TAGs, and the at least one cell comprising the first cell.

In some embodiments, the method further comprises: configuring a cell group for a media access control (MAC) entity, the first cell group comprising at least one cell configured as associated with at least one of the plurality of TAGs, and the at least one cell comprising the first cell.

In some embodiments, the first cell is configured with a MTRP mode.

In some embodiments, the first cell is configured with an inter-cell MTRP mode with a second cell, and a total number of TAGs associated with the first cell and the second cell is lower than or equal to a predefined number.

In some embodiments, the second cell is configured to be associated with the plurality of TAGs.

In some embodiments, the method further comprises: receiving, from the network device, information indicating a plurality of timing advance (TA) offset values for the first cell; and associating the plurality of TA offset values with the plurality of TAGs.

In some embodiments, the method further comprises: applying one of the plurality of TAGs based on the plurality of TA offset values.

In some embodiments, applying one of the plurality of TAGs comprises: applying a TAG associated with a largest TA offset value for at least one of the following: an inter-cell operation, a cell configured with a dual connection, a cell configured with an unlicensed spectrum, or a cell configured with a different full duplex mode.

In some embodiments, the method further comprises: receiving, from the network device, a MAC control element (CE) containing a plurality of TA commands for the plurality of TAGs, the plurality of TA commands being associated with a plurality of identities of the plurality of TAGs in the MAC CE.

In some embodiments, the configuration information further indicates an association relationship between the plurality of TAGs and at least one of the following: resources, TRPs, TCI states, or spatial relations. In some embodiments, the method further comprises: receiving, from the network device, a switching command, the switching command indicating at least one of the following: switching from a first resource to a second resource, switching from a first TRP to a second TRP, switching from a first TCI state to a second TCI state, or switching from a first spatial relation to a second spatial relation; and in response to the switching command, performing at least one of the following: switching from a first TA value of a first TAG associated with at least one of the first resource, the first TRP, the first TCI state, or the first spatial relation to a second TA value of the first TAG associated with at least one of the second resource, the second TRP, the second TCI state, or the second spatial relation, stopping a first timer associated with the first TAG, or starting a second timer associated with the second TAG.

In some embodiments, the method further comprises: transmitting, to the network device, capability information indicating at least one of the following: whether the terminal device supports a plurality of TAGs for a cell, the number of TAGs supported by the terminal device, a combination of TAGs supported by the terminal device, the number of cells that can be configured with the plurality of TAGs, whether the terminal device supports different TAGs in adjacent cells, a total number of TAGs to be supported for the cell or for adjacent cells, or whether the terminal device supports different TAGs simultaneously.

In some embodiments, the method further comprises: determining, from a plurality of BWPs of the first cell, at least one BWP configured with a MTRP mode; determining a first reference subcarrier spacing (SCS) from at least one SCS of the at least one determined BWP of the first cell; and determining an UL transmission timing for at least one of the plurality of TAGs based at least in part on the first reference SCS.

In some embodiments, the method further comprises: determining a second reference SCS at least from at least one SCS of at least one cell associated with at least a first TAG of the plurality of TAGs; and determining, based at least in part on the second reference SCS, a plurality of UL transmission timings for the plurality of TAGs.

In some embodiments, determining the second reference SCS comprise: determining the second reference SCS from a plurality of SCSs of a plurality of BWPs configured for cells associated with the plurality of TAGs.

In some embodiments, determining the plurality of UL transmission timings comprises: receiving, from the network device, a MAC control element (CE) containing a plurality of TA commands for the plurality of TAGs; and in response to the MAC CE, determining the plurality of UL transmission timings for the plurality of TAGs based at least in part on the second reference SCS and the plurality of TA commands.

In some embodiments, the method further comprises: determining a plurality of reference SCSs for the plurality of TAGs, respectively; and determining a plurality of UL transmission timings for the plurality of TAGs based on the plurality of reference SCSs, respectively.

In some embodiments, the plurality of TAGs comprises two TAGs.

In another solution, a communication method comprises: receiving, at a terminal device and from a network device, configuration information indicating a plurality of timing advance groups (TAGs) associated with a first cell of the terminal device; receiving, from the network device, a plurality of timing advance (TA) commands for the plurality of TAGS; determining a start time point for the plurality of TAGs, the start time point indicating when the plurality of TA commands are to be applied; and in accordance with a determination that an active BWP of the first cell is configured with a multi-transmission reception point (MTRP) mode, applying the plurality of TA commands from the determined start time point.

In some embodiments, determining the start time point comprises: determining a plurality of values for a predetermined parameter for calculating the start time point based on corresponding bandwidth part (BWP) related information in the plurality of TAGs; selecting one of the plurality of values for the predetermined parameter; and determining the start time point based on the selected value for the predetermined parameter.

In some embodiments, the method further comprises: in accordance with a determination that an active BWP of the first cell is configured with an MTRP mode, applying the plurality of TA commands from the determined start time point.

In some embodiments, the method further comprises: in accordance with a determination that the terminal device switches from a first BWP to a second BWP before the start time point, in accordance with a determination that the second BWP is associated with a first TAG, determining a first TA value for the first TAG based on a first TA command for the first TAG and a reference SCS of the second BWP; and in accordance with a determination that the second BWP is not associated with the second TAG and the first BWP is associated with the second TAG, determining a second TA value for the second TAG based on a second TA command for the second TAG and a reference SCS of the first BWP.

In some embodiments, the method further comprises: determining a plurality of TA values for the plurality of TAGs by applying the plurality of TA commands, respectively; in accordance with a determination that the terminal device switches from a first BWP to a second BWP after the start time point, maintaining at least one of the plurality of TA values for at least one of the plurality of TAGs.

In some embodiments, the plurality of TAGs comprises two TAGs.

In a further solution, a communication method comprises: receiving, at a terminal device and from a network device, configuration information indicating a plurality of timing advance groups (TAGs) associated with a cell for the terminal device; selecting a target TAG from the plurality of TAGs based on a TAG selection criterion for a communication procedure; and performing the communication procedure with the network device based at least on the target TAG.

In some embodiments, the TAG selection criterion is based on at least one of the following: a plurality of identities of the plurality of TAGs, a plurality of timing advance (TA) values of the plurality of TAGs, a first association relationship between bandwidth parts (BWPs) and the plurality of TAGs, a second association relationship between at least one transmission reception point (TRP) and the plurality of TAGs, a third association relationship between at least one control resource set (CORESET) and the plurality of TAGs, or a fourth relationship between a set of reference signals available for beam failure recovery (BFR) and the plurality of TAGs.

In some embodiments, in the first association relationship, a BWP associated with the target TAG comprises a BWP configured with a sidelink operation.

In some embodiments, in the second association relationship, a TRP associated with the target TAG comprises one of the following: a predefined TRP, an indicated reference TRP, a main TRP, a TRP corresponding to a CORESET pool, a TRP corresponding to a transmission configuration indicator (TCI) state, or a TRP corresponding to a resource.

In some embodiments, the communication procedure comprises a supplementary uplink (SUL) operation procedure, and performing the communication procedure comprises: applying, during the SUL operation procedure, a TA value of the target TAG.

In some embodiments, the communication procedure comprises a sounding procedure, and performing the communication procedure comprises: determining, based on the target TAG, a set of carriers from which a sounding procedure is available to be switched to a further carrier, the set of carriers being at least in the same target TAG.

In some embodiments, the communication procedure comprises a sidelink communication procedure, and performing the communication procedure comprises: determining a TA value associated with the target TAG; and determining a sidelink resource allocated for the terminal device based on the determined TA value.

In some embodiments, the communication procedure comprises a beam failure recovery (BFR) procedure, and the target TAG comprises a TAG associated with a reference signal selected from a set of reference signals for BFR, determining a TA value of the target TAG; and applying the TA value for a beam failure detection (BFD) operation based on the selected reference signal.

In some embodiments, the method further comprises: in accordance with a determination that the BFD operation is failed, stopping a timer associated with the target TAG; and triggering a random access procedure to request a further TA value for the target TAG.

In some embodiments, the BFR procedure is performed for a plurality of TRPs, the plurality of TRPs being associated with the plurality of TAGs, and the method further comprises: in accordance with a determination that BFD operations with the plurality of TRPs are failed, stopping a plurality of timers associated with the plurality of TAGs; and triggering a plurality of random access procedures to request respective TA values for the plurality of TAGs.

In some embodiments, the plurality of TAGs comprises two TAGs.

In a further solution, a terminal device comprises: at least one processor; and at least one memory storing instructions that, when executed by the at least one processor, cause the device to perform any of the methods implemented by the terminal device above.

In a further solution, a computer readable medium having instructions stored thereon, the instructions, when executed on at least one processor, causing the at least one processor to perform any of the methods implemented by the terminal device above.

In a yet further solution, a computer program comprising instructions, the instructions, when executed on at least one processor, causing the at least one processor to perform any of the methods implemented by the terminal device above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method, performed by a terminal device, the method comprising:
receiving, from a network device, a configuration comprising information indicating two timing advance groups (TAGs) for a cell; and
indicating a positive acknowledgement for a semi-persistent scheduling (SPS) deactivation comprised in a downlink reception, in a case where:
a timer of a timing advance group (TAG) from the two TAGs is running, and
the TAG is associated with a transmission configuration indicator (TCI) state used for transmitting a hybrid automatic repeat request (HARQ) feedback comprising the positive acknowledgement.

22. The method of claim 21, the method comprising:
not instructing a physical layer to generate an acknowledgement for a data in a TB, in a case where:
the timer of the TAG from the two TAGs is not running, and
the TAG is associated with a TCI state used for transmitting a HARQ feedback to comprise the acknowledgement.

23. The method of claim 21, wherein
the two TAGs do not be applied for a transmission on a supplementary uplink (SUL) carrier.

24. A method, performed by a network device, the method comprising:
transmitting, to a terminal device, a configuration comprising information indicating two timing advance groups (TAGs) for a cell; and
receiving a positive acknowledgement for a semi-persistent scheduling (SPS) deactivation comprised in a downlink transmission, in a case where:
a timer of a timing advance group (TAG) from the two TAGs is running, and
the TAG is associated with a transmission configuration indicator (TCI) state used for a hybrid automatic repeat request (HARQ) feedback comprising the positive acknowledgement.

25. The method of claim 24, wherein:
not receiving, from the terminal device, an acknowledgement for a data in a TB, in a case where:
the timer of the TAG from the two TAGs is not running, and
the TAG is associated with a TCI state used for a HARQ feedback to comprise the acknowledgement.

26. The method of claim 24, wherein
the two TAGs do not be applied for a transmission on a supplementary uplink (SUL) carrier.

27. A terminal device, comprising a processor configured to cause the terminal device to:
receive, from a network device, a configuration comprising information indicating two timing advance groups (TAGs) for a cell; and
indicate a positive acknowledgement for a semi-persistent scheduling (SPS) deactivation comprised in a downlink reception, in a case where:
a timer of a timing advance group (TAG) from the two TAGs is running, and
the TAG is associated with a transmission configuration indicator (TCI) state used for transmitting a hybrid automatic repeat request (HARQ) feedback comprising the positive acknowledgement.

28. The terminal device of claim 27, wherein the processor is configured to cause the terminal device to:
not instruct a physical layer to generate an acknowledgement for a data in a TB, in a case where:
the timer of the TAG from the two TAGs is not running, and
the TAG is associated with a TCI state used for transmitting a HARQ feedback to comprise the acknowledgement.

29. The terminal device of claim 27, wherein
the two TAGs do not be applied for a transmission on a supplementary uplink (SUL) carrier.

30. A network device, comprising a processor configured to cause the network device to:
transmit, to a terminal device, a configuration comprising information indicating two timing advance groups (TAGs) for a cell; and
receiving a positive acknowledgement for a semi-persistent scheduling (SPS) deactivation comprised in a downlink transmission, in a case where:
a timer of a timing advance group (TAG) from the two TAGs is running, and
the TAG is associated with a transmission configuration indicator (TCI) state used for a hybrid automatic repeat request (HARQ) feedback comprising the positive acknowledgement.

31. The network device of claim 30, wherein:
not receiving, from the terminal device, an acknowledgement for a data in a TB, in a case where:
the timer of the TAG from the two TAGs is not running, and
the TAG is associated with a TCI state used for a HARQ feedback to comprise the acknowledgement.

32. The network device of claim 30, wherein
the two TAGs do not be applied for a transmission on a supplementary uplink (SUL) carrier.
